(19) United States
(12) Patent Application Publication
(10) Pub. No.: US 2026/0142826 A1
(43) Pub. Date: May 21, 2026

(54) Secure Message Lifecycle Management Using Off-Chain Storage and Blockchain-Anchored Event Records

(71) Applicant: GOLOGIC GROUP PTY LTD, ALEXANDRA HEADLAND (AU)

(72) Inventors: Bradley M. DAVIS, ALEXANDRA HEADLAND (AU); Clint BETTS, ALEXANDRA HEADLAND (AU); Rodan D'ROZARIO, ALEXANDRA HEADLAND (AU); Nathaniel JACOBS, ALEXANDRA HEADLAND (AU); Andrew NAPIER, ALEXANDRA HEADLAND (AU)

(21) Appl. No.: 19/448,698

(22) Filed: Jan. 14, 2026

Related U.S. Application Data
(63) Continuation-in-part of application No. PCT/AU2024/050748, filed on Jul. 12, 2024.

(30) Foreign Application Priority Data
Jul. 14, 2023 (AU) 2023902265

(51) Int. Cl. H04L 9/32

(52) U.S. Cl. CPC H04L 9/3236

(57) ABSTRACT

A computer-implemented method for managing secure message content is described. Message content associated with a message is received and stored in an off-chain content store. A payload identifier is generated that uniquely identifies the content independently of its physical storage location, and a first cryptographic hash of the stored content is computed. An off-chain mapping store holds a mapping record keyed by the payload identifier, including location data for retrieving the content and the first hash. A message event item including the payload identifier, the first hash and message lifecycle data is serialised into a canonical representation, hashed to obtain an event hash, and immutably anchored on a blockchain. Upon a subsequent access request, the associated message event item is re-serialised and verified against the blockchain event hash before the payload identifier is used to locate and retrieve the content. A third hash of the retrieved content is compared with the first hash to decide whether to release or withhold the content.

### TECHNICAL FIELD

The present disclosure relates to the communication and management of electronic messages and associated data. In one form, the present disclosure relates to systems and methods for handling sensitive or regulated information, such as healthcare or medical data, using off-chain storage, event-sourced message histories and blockchain-based verification to provide secure, integrity-checked and auditable message transmission.

### BACKGROUND

Many industries, such as the healthcare industry, have long had strict requirements regarding communications, to ensure sensitive information remains protected. This has resulted in the slow adoption of digital communications technology for the communication of sensitive information, as it has lacked the security required for such sensitive information. As an illustrative example, ordinary email is generally not considered sufficiently secure for sending sensitive information, as it is vulnerable to interception.

More recently, secure messaging systems have been introduced for such purposes, where secure messages are sent between parties using one or more secure messaging providers. These systems require the senders and recipient(s) to log into the system to send and receive messages. The channels to and from the system (i.e. between the sender and the system, and between the recipient and the system) are encrypted, thereby preventing unauthorised interception of data.

One problem with such currently used secure messaging systems is that the systems have access to the sensitive information, and as such, if such systems are compromised, the sensitive data may be leaked.

Another problem with such currently used secure messaging systems is that it is difficult to keep track of what has been received and read by whom. As an illustrative example, in the case of unauthorised access by the system, data may be deleted or modified, without the sender or recipient knowing.

Certain communications system exist that include end-to-end encryption, e.g. based upon email. A problem with such systems is that data can easily be sent to the wrong recipient, and it is difficult to determine that data has been received by the correct recipient. As a result, important information can be missed, which can have devastating consequences.

Similar problems exist with communications outside the healthcare industry, where sensitive information is being handled, including in the banking and finance sectors, education, and legal industries.

Electronic messaging systems are widely used to exchange information between individuals, organisations and software systems. In many domains, including healthcare, financial services and government, messages may contain sensitive or regulated information that must be transmitted securely and in a manner that supports later verification and audit. Conventional approaches typically rely on a combination of encrypted transport, secure storage and database records that track message status, such as whether a message has been sent, delivered or read. Audit logs or activity logs may also be maintained to provide some visibility into historical actions that have occurred in relation to a message.

These existing approaches can be limited when a strong, tamper-evident record of message history and content integrity is required. Message status is often stored as a mutable field in a database record and can be changed without leaving a clear, machine-verifiable trail. Audit logs are frequently incomplete or inconsistent between systems, and may not be designed to support reliable reconstruction of the full lifecycle of a message. Storing complete message content on a blockchain or similar immutable ledger is generally undesirable due to privacy, storage and regulatory concerns. There is therefore a need for improved techniques for communicating and managing sensitive messages which allow message content to remain off-chain, while providing a robust, verifiable and auditable record of message lifecycle events and content integrity.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

The present disclosure addresses a number of technical problems that arise when attempting to manage sensitive electronic messages in a way that is both operationally practical and strongly auditable. A first problem is how to obtain proof of message integrity without storing the message content itself on an immutable or public ledger. A second problem is how to represent the full lifecycle of a message-including sending, delivery, reading, forwarding, deletion, failures and eventual resolution-in a form that can be reliably replayed to derive the current state, rather than relying on mutable status fields that can be altered without leaving a verifiable trail. A third problem is that conventional logging mechanisms do not define a clear, finite vocabulary of lifecycle events, particularly for error and resolution conditions, making it difficult for machines or verifying users to reconstruct exactly what happened to a message and when.

To address these problems, the techniques described herein combine: off-chain message content storage linked to logical payload identifiers and cryptographic integrity values; an event-sourcing architecture in which every lifecycle change is recorded as an append-only message event whose hash is anchored on a blockchain; and a defined set of message lifecycle event types, in some embodiments including, for example, a RESOLVED event, with state transition rules that derive trusted and resolved states from the ordered event stream. Together, these features enable message content to remain in flexible off-chain storage while providing a replayable and semantically well-defined history of each message's lifecycle and integrity status.

As used herein, a “payload identifier” is a logical identifier for stored message content. In some implementations, the payload identifier corresponds to or includes an existing content identifier used by the messaging platform to identify encrypted content in an off-chain store. In other implementations, the payload identifier may be distinct from the message identifier (also referred to as the transaction ID) and distinct from the payload structure (e.g., as described with reference to FIGS. 9A to 9C elsewhere herein).

As used herein, an “integrity value” is any value derived from message content that enables subsequent verification of that content, such as a cryptographic hash (for example, SHA-256, SHA-512 or a SHA-3 variant) or a message authentication code (MAC). In the example embodiments described herein, the integrity value is typically a cryptographic hash of the encrypted message payload.

According to an embodiment, the present disclosure relates to a communications method for verifying secure message transmission. The method comprises receiving, from a sending device, a message associated with a recipient; generating, using a processor, an event item associated with the message; generating, using the processor, a cryptographic hash of the event item; storing, on a blockchain, the cryptographic hash of the event item or a derivative thereof; and enabling the recipient of the message to access, on a data interface, the message. The method further comprises providing the cryptographic hash together with the event item to a verifying user enabling the verifying user to compare the cryptographic hash and the event item in order to verify secure message transmission.

According to one or all embodiments, the method further comprises verifying secure message transmission by comparing the cryptographic hash and the event item. According to one or all embodiments, the generating the event item comprises generating an event object using an event sourcing database. According to one or all embodiments, the event object comprises event data associated with message actions selected from a group comprising: sending, receiving, altering, reading, forwarding and deleting. According to one or all embodiment, the event data comprises one or more message features selected from a group comprising: an event identifier, an event name, a timestamp, a transaction identifier, a sender, a recipient, a payload, and a payload type. According to one or all embodiments, the method further comprising disallowing access to the message by the verifying user.

Some secure messaging systems of the current technology may incorporate aspects of blockchain technology, because blockchain is typically used to ensure that data cannot be altered retroactively. However, using blockchain for secure messaging can have some drawbacks. It can suffer from scalability and performance issues due to the decentralised consensus and cryptographic operations involved. Storing messages on a blockchain requires significant storage space and can lead to increased costs.

Privacy concerns may arise since blockchain's transparency does not inherently provide strong privacy protections for message content. In one or all implementations, blockchain's decentralised nature may present challenges related to regulatory compliance and user experience, especially in managing cryptographic keys and navigating unfamiliar interfaces.

The inventors realised that the problem to be solved in many applications is not necessarily limiting access to a message. Instead, the problem can be reframed as “monitoring whether a message has been accessed”. With this novel perspective, the inventors have created a unique method and system for monitoring the transmission of secure messaged that uses event sourcing technology.

Event sourcing is particularly useful in domains where auditability is crucial, such as financial systems, or where tracking user behaviour and order history is important, like in e-commerce platforms. It is also beneficial in microservices architectures for better service isolation and decoupling. Event sourcing provides a robust foundation for building scalable, maintainable, and auditable systems. The inventors have uniquely identified the value of this type of technology within the context of secure messaging.

Specifically, the inventors have developed a robust yet computationally elegant method in which the blockchain is used to verify that the transaction history has not been altered after the event.

In one embodiment, there is provided a computer-implemented method for managing message content using off-chain storage and blockchain-based event records. The method includes receiving message content associated with a message, generating a payload identifier that uniquely identifies the message content independently of any physical storage location, and storing the message content in an off-chain content store. The method further includes computing a first cryptographic hash over the stored message content and, in an off-chain mapping store, storing a mapping record keyed by the payload identifier, the mapping record including at least location data for retrieving the message content from the off-chain content store and the first cryptographic hash. A message event item is generated that includes at least the payload identifier, the first cryptographic hash and message lifecycle data, and the message event item is serialised into a canonical representation and a second cryptographic hash is computed over the canonical representation to obtain an event hash. A blockchain transaction including the event hash is recorded on a blockchain, thereby immutably anchoring the message event item without storing the message content on the blockchain. Responsive to a subsequent request to access the message content, the payload identifier and an associated message event item are obtained, the associated message event item is serialised into the same canonical representation and a verification hash is computed over that canonical representation, and the verification hash is compared with the event hash recorded on the blockchain for the associated message event item. When the verification hash does not correspond to the retrieved event hash or the event hash cannot be retrieved from the blockchain, the method refrains from providing the message content. When the verification hash corresponds to the retrieved event hash, the payload identifier is used to retrieve the mapping record from the off-chain mapping store and the location data in the mapping record is used to retrieve the message content from the off-chain content store. A third cryptographic hash is computed over the retrieved message content and compared with the first cryptographic hash obtained from the mapping record. When the third cryptographic hash matches the first cryptographic hash, the retrieved message content is treated as valid and the message content is provided to an authorised recipient, and when the third cryptographic hash does not match the first cryptographic hash or the message content cannot be retrieved from the off-chain content store, the method refrains from providing the message content. In some embodiments, the payload identifier is generated as a logical identifier that does not encode the off-chain content store or a physical storage path, and the mapping record provides an indirection layer between the payload identifier and a physical storage location. In some embodiments, the off-chain mapping store comprises an indexable database and the mapping record is a database row keyed by the payload identifier, the database row including at least a content store type, a container or bucket identifier and an object key. In some embodiments, the message event item represents a specific lifecycle event for the message selected from the group consisting of: message sent, message delivered, message read, message replied, message forwarded and message deleted. In some embodiments, the canonical representation of the message event item is a structured data encoding with a defined field ordering such that repeated serialisation of the same logical event item yields the same byte sequence for hashing. In some embodiments, when the third cryptographic hash does not match the first cryptographic hash or the message content cannot be retrieved from the off-chain content store, the method further comprises generating a further message event item indicating an integrity failure condition associated with the payload identifier, serialising the further message event item and computing a further cryptographic hash over the serialised further message event item, and recording on the blockchain a blockchain transaction that includes the further cryptographic hash, the further message event item being used to block subsequent attempts to access the message content via the payload identifier and to provide an auditable indication to a verifying user that the message content was unavailable or failed integrity verification at a recorded time.

In another embodiment, there is provided a computer-implemented method for managing secure messages using event-sourced histories with off-chain content storage and blockchain-based verification. The method includes receiving message content associated with a message, assigning a unique message identifier to the message and storing the message content in an off-chain content store. A payload identifier is generated for the message content, the payload identifier being independent of a physical storage location of the message content, and a mapping record keyed by the payload identifier is stored in an off-chain mapping store, the mapping record including at least location data for retrieving the message content from the off-chain content store and an integrity value associated with the message content. For each lifecycle change associated with the message, including at least a sending action and one or more actions selected from delivering, reading, forwarding, deleting and reporting an integrity failure, the method generates a message event comprising at least the unique message identifier, an event type identifying the lifecycle change, the payload identifier and event metadata, and appends each message event, in an append-only manner, to an event store in association with the unique message identifier so as to form an ordered event stream for the message. For each message event, an event hash representative of the message event is derived and the event hash is recorded on a blockchain, thereby immutably anchoring the ordered event stream without storing the message content on the blockchain. Responsive to a request for a current state of the message, the ordered event stream is retrieved from the event store and processed according to state transition rules to obtain a state representation used as the current state of the message. Responsive to a request to access the message content, the payload identifier is obtained from the state representation or from a message event in the ordered event stream, the payload identifier is used to retrieve the mapping record from the off-chain mapping store and the location data in the mapping record is used to retrieve the message content from the off-chain content store. An integrity value derived from the retrieved message content is compared with the integrity value stored in the mapping record, and when the integrity values do not correspond or the message content cannot be retrieved, the method refrains from providing the message content and generates a further message event indicating an integrity failure condition, the further message event being appended to the event store and anchored on the blockchain in the same manner as other message events, such that the current state and integrity status of the message are defined by the ordered sequence of stored, blockchain-anchored message events rather than by a separately maintained mutable status record. In some embodiments, the integrity value comprises a cryptographic hash of the message content. In some embodiments, deriving the event hash comprises serialising the message event into a canonical representation and computing a cryptographic hash over the canonical representation. In some embodiments, the event store maintains a per-message event stream in which message events associated with a given unique message identifier are stored and retrieved in sequence order. In some embodiments, the state transition rules map event types in the ordered event stream to message status values including at least one of: sent, delivered, read, forwarded, deleted and integrity failed. In some embodiments, the further message event indicating the integrity failure condition is used to block subsequent access attempts to the message content via the payload identifier and to provide an auditable indication that the message content was unavailable or failed integrity verification at a recorded time.

In a further embodiment, there is provided a computer-implemented method for managing secure message lifecycles. The method includes receiving message content and creating a message record having a unique message identifier, and defining, in a messaging system, a finite set of message lifecycle event types. The event types may include one or more of: an event type for message transmission, an event type for message receipt, an INTEGRITY-FAILURE event type, and/or a RESOLVED event type. For each lifecycle change that occurs for the message, the method generates a message event of one of the defined event types, the message event including at least the unique message identifier, an event type identifier and a timestamp, and appends each generated message event, in an append-only manner, to an event store in association with the unique message identifier so as to form an ordered event stream for the message. For each message event, an event hash representative of the message event is derived and the event hash is recorded on a blockchain, thereby immutably anchoring the ordered event stream without storing the message content on the blockchain.

Responsive to a request for a current state of the message, the ordered event stream is retrieved from the event store and processed according to state transition rules that map the defined event types to message status values. In some embodiments this may include mapping an INTEGRITY-FAILURE event to a state in which the message is marked not trusted and mapping a RESOLVED event.

The RESOLVED event may include a resolution payload describing a resolution of the message, to a state in which the message is marked resolved.

The current state of the message, including at least a trust status and a resolution status, is determined from the ordered sequence of stored, blockchain-anchored message events and is not maintained as a separately updated mutable status field.

In some embodiments, the finite set of message lifecycle event types further comprises at least a SEND event type and a DELIVERED event type, the SEND event type corresponding to transmission of the message content and the DELIVERED event type corresponding to receipt of the message at a recipient endpoint. In some embodiments, each message event further includes a payload identifier that identifies message content stored in an off-chain content store and an integrity value associated with the message content, the integrity value comprising a cryptographic hash of the message content.

In some embodiments, deriving the event hash comprises serialising the message event into a canonical representation and computing a cryptographic hash over the canonical representation such that repeated serialisation of the same logical message event yields the same event hash.

In some embodiments, an INTEGRITY-FAILURE event may be generated when an integrity value derived from retrieved message content does not correspond with an integrity value stored for that content; the INTEGRITY-FAILURE event may be appended to the ordered event stream for the message and anchored on the blockchain in the same manner as other message events.

In some embodiments, at most one RESOLVED event is permitted as a primary resolution for a given unique message identifier, and any subsequent RESOLVED events for that unique message identifier are treated as updates or annotations to an existing resolution state in the state transition rules.

Throughout this specification the word “comprise” or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 illustrates an embodiment of a communications system.

FIG. 2 illustrates a simplified schematic of an embodiment of a message payload of the system of FIG. 1.

FIG. 3 illustrates a simplified schematic of an embodiment of a sent event item.

FIG. 4 illustrates an embodiment of a delivered event item.

FIG. 5 illustrates a simplified schematic of an embodiment of a portion of the blockchain of the system of FIG. 1.

FIG. 6 illustrates an embodiment of a communications method.

FIG. 7 shows an embodiment of a communications system.

FIG. 8 is a block diagram of an example embodiment of a computing device.

FIG. 9A shows an embodiment of an encrypted text message payload.

FIG. 9B shows an embodiment of a sent event item.

FIG. 9C shows an embodiment of a delivered or read event item.

FIG. 10 shows an embodiment of a user interface display.

FIG. 11 shows another embodiment of a user interface display.

FIG. 12 shows another embodiment of a user interface display.

FIG. 13 shows an embodiment of a method for managing message content using off-chain storage.

FIG. 14 is a flow diagram of an embodiment of a computer-implemented method for managing secure messages.

FIG. 15 is a flow diagram of an embodiment of a computer-implemented method for managing secure message lifecycles.

In the drawings, like reference numerals designate similar parts.

### DETAILED DESCRIPTION

Embodiments of communications systems and methods are described below that support confidentiality, auditability and authentication when parties communicate data, such as documents or other communications, with each other remotely.

The communications methods comprise using an event sourcing database as a transaction history for messages sent and received via a digital platform. Event data is generated, a hash function is applied to generate a cryptographic hash of the event data, a transaction is prepared to store the generated hash value on a blockchain platform, the transaction is executed by submitting it to the blockchain for inclusion in a block, thereby storing a secure and tamper-proof representation of the original event data on the blockchain in the form of a cryptographic hash of the event data. In this way, a verifiable record of events that ensures data integrity and immutability is created.

Advantageously, by storing the cryptographic hash or a derivative thereof on the blockchain, an immutable record of the message is provided, without storing or disclosing the message itself on the blockchain. This enables auditing to be performed in a transparent manner, without compromising the data of the message.

### Embodiments of Communications Systems

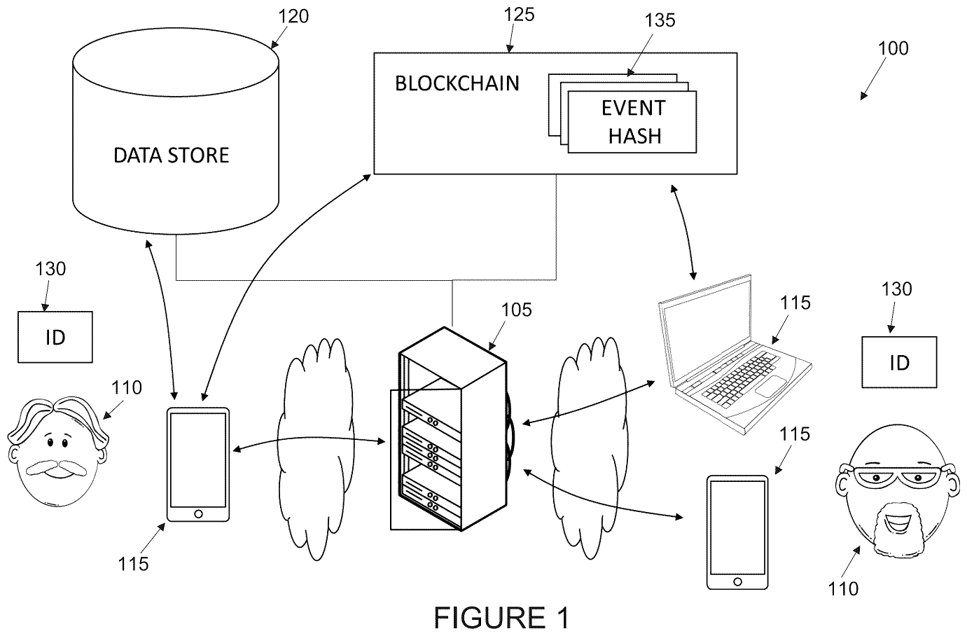

FIG. 1 illustrates an embodiment of a communications system 100. The communications system 100 includes one or more servers 105, with which a plurality of users 110 interact, using respective computing devices 115. The servers 105 function in part as web servers, and provide user interfaces with which the users 110 interact.

The servers 105 also provide an interface to a data store 120 and a blockchain 125, for storing data and an audit of interactions, among other things, as outlined in further detail below.

Initially, the users 110 each create a user ID 130, which is used with interactions with the communications system 100. The user IDs 130 are verified by the system 100, providing a verifiable trust mechanism when sending or receiving data through the system.

In particular, the user 110 interacts with the servers 105, to generate the ID 130. This process may include uploading identity documents, such as a driver's license, performing an identity check, and/or performing third-party verification. The user 110 also enters communications details, such as a phone number, fax number, email address, or similar, which are also used for verification. The servers 105 verify access to these communications, e.g. by sending codes or other messages to the phone number, fax number or email address, such codes later being entered into the user interface to verify access to the communications.

Different levels of verification may be used based upon a role of the user 110. As an illustrative example, basic user access may be provided upon verification of a mobile phone number. Advanced verification may, on the other hand, be required when sensitive information is being dealt with.

Once the identity of the user 110 is verified, the user ID 130 may be used for communicating between users 110, much like an email address or fax number has traditionally been used. The user ID 130 may be linked to a phone number, fax number, email address or the like.

The user ID 130 may be published on an online directory of the system 100, and publicly available to anyone. In such case, details of the user 110, such as name and other details, may be published on the directory, to enable persons to easily search for user IDs.

In other embodiments, however, the user ID 130 may be private, requiring the user 110 to provide their user ID 130 to other parties for communications. Such configuration is useful when users 110 wish to minimise or avoid cold contact.

The user ID 130 is associated with public and private encryption keys, to enable encryption and authentication of messages with the system 100. The public key is published in association with the user ID 130, and the private key is kept private by the user 110, as is well known in the art of asymmetric encryption.

While the term “user” is used here, the skilled addressee will readily appreciate that an organisation (with multiple associated individuals) may be associated with a user ID 130, rather than an individual. This is particularly relevant where hospitals, pathologists, medical centres, law firms, accountancy firms, or the like communicate, which have multiple individuals (e.g. doctors, lawyers or other staff), each having access to the system 100.

When a user 110 wishes to send information to another user 110, the user 110 initially creates a message comprising data to be sent at their computing device 115. The data may include documents, images, audio, text, files, or any suitable data.

In one or all embodiments, once the message comprising the data has been created, it may be hashed, at the computing device 115, using a known hash algorithm that takes messages and converts them to a binary string of fixed size, such that the hash is representative of the message. As an illustrative example, Secure Hash Algorithm 3 (SHA-3) may be used to generate a binary string of 224, 256, 384, or 512 bits.

Additionally or alternatively, the message may be encrypted, at the computing device 115, using a public key of recipient. The encrypted message may be hashed using the known hash algorithm.

The message is then uploaded to the server 105, together with a hash of the unencrypted message, and a hash of the encrypted message.

Anyone may subsequently take the message or the encrypted message, generate a hash using the same known hash algorithm, and compare the hash, to verify that the message has not been altered or replaced. For example, a recipient may, upon receiving the message and its hash, compute the hash of the received message using the same hash function and compare the computed hash value with the hash value received from the sender; if the two hash values match, it confirms that the message has not been altered during transit.

Encrypting the message at the computing device of the sender ensures that only the recipient can decrypt and thus read the message. The server 105, for example, is not able to decrypt the message, as it does not have the private key of the recipient, meaning that even if the server 105 is compromised, no sensitive data will be leaked from the message.

The private key of the sender may be used to sign the message, enabling the server 105 to authenticate the origin of the message, and that it has not been tampered with. Alternatively, an encrypted communications channel between the sender and the server 105, e.g. comprising transport layer security or the like, may be used to authenticate the user 110.

Once the sender is authenticated, the encrypted message is stored on the data store 120 associated with the server 105. A payload of the message is then generated, for use by an event system, as outlined in further detail below.

In one or all embodiments, the communications system comprises at least one computing device that includes a data interface, a processor coupled to the data interface, and a memory, coupled to the processor. The memory includes instruction code executable by the processor for generating or receiving a message associated with at least one recipient, for generating, using the processor, a cryptographic hash of at least part of the message and/or an event item associated with the message, and for storing, on a blockchain, the cryptographic hash(es) and/or a derivative thereof. The instruction code may further cause the processor to enable a recipient to access, on the data interface, the message.

The system may comprise or interact with a third-party Secure Message Delivery (SMD) system. The system may support messages according to the Clinical Document Architecture (CDA) standard.

The messages may comprise eReferrals, specialist letters, prescriptions, lab results, diagnoses outcomes, and/or discharge summaries. The messages may comprise receipts, invoices, credit notes, purchase orders, quotations, surveys, contracts, presentations, assignments, reports, specifications, schematics, maps, charts, images, documents, data, or files.

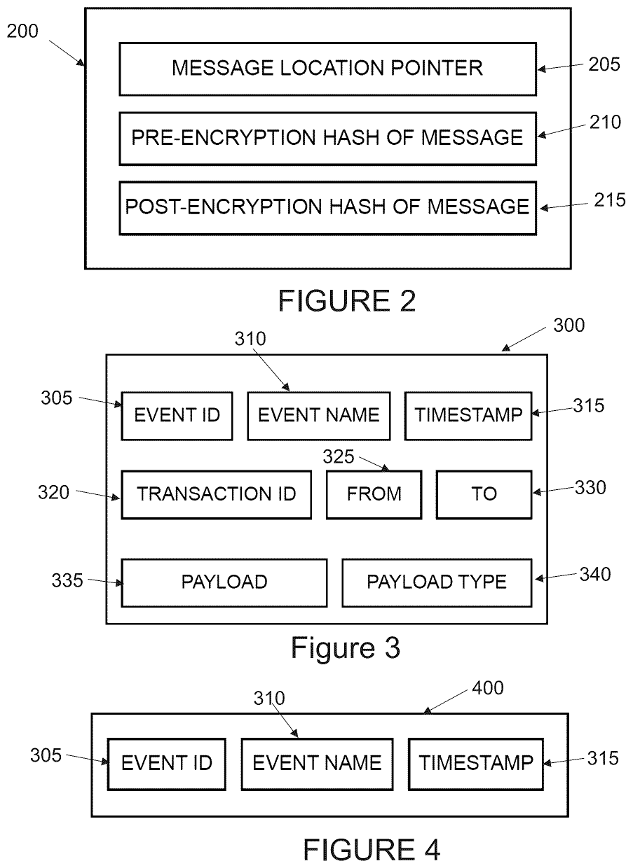

FIG. 2 illustrates a simplified schematic of an embodiment of a message payload 200. The message payload 200 may be similar or identical to the message payloads used by the system 100.

The message payload 200 includes a message location pointer 205, which comprises a pointer (e.g. a URL) to a location on a data store, such as a location on the data store 120, together with a hash of the message 210, and a hash of the encrypted message 215.

The pointer points to the actual contents of the encrypted message, such as encrypted text, images, sound, files, etc.

The message payload 200 may further include a digital sender's signature (not shown), to enable any entity to authenticate the message. In particular, the digital signature comprises a signature of the message using the sender's private key, which can be verified using the sender's public key, which is publicly available.

A notification is then sent to the recipient, indicating that the message is able to be accessed. This may be by providing an indicator in an inbox of the user 110, by providing a notification, or any suitable means.

A ‘sent’ event is then generated corresponding to the ‘sending’ of the message to the recipient, which is hashed and stored on the blockchain.

FIG. 3 illustrates an embodiment of a simplified schematic of a sent event item 300. The sent event item 300 may be similar or identical to the ‘sent’ event used by the system 100.

The sent event item 300 comprises a unique event identifier 305, an event name 310, specifying the type of event (in this case a ‘sent’ event), and a timestamp 315 relating to when the message was sent. These parameters are common across all events, as illustrated in further detail below.

The sent event item 300 further includes a transaction ID 320, a from element 325, a to element 330, a payload element 335 and a payload type 340.

The transaction ID 320 is a unique identifier used to identify a particular message, i.e. in this example the transaction ID serves as the unique message identifier (MID) for the message. The from and to elements 325, 330 are used to identify who the message is from and who the message is to (i.e. sender and recipient). These elements may include email addresses or similar identifiers associated with public and private keys (for encryption purposes), and may be similar or identical to the user ID 130 of FIG. 1. The payload element 335 includes the message payload, which may be similar or identical to the message payload 200. Finally, the payload type 340 identifies how to interpret the payload, and may include version numbering, or any suitable indicator of how to interpret the payload.

Such configuration is particularly useful as it allows for easy expansion of event types (through different event names), but also expansion of payload formats through the addition of new payload types.

The sent event item 300 is then hashed, again using the known hash algorithm to generate an event hash, which is stored on the blockchain.

The recipient is able to access the server 105 and request a copy of the message. The recipient is then provided the encrypted message, and can proceed to decrypt the message on their portable computing device 115 with their private key, and without needing to share their private key with the server 105.

The private key of the recipient may similarly be used for authentication with the server 105, enabling the server 105 to verify that the recipient (and not another user 110) that has accessed the message. Alternatively, an encrypted communications channel between the sender and the server, e.g. comprising transport layer security or the like, may be used to authenticate the recipient.

The recipient's interactions with the message, including receipt thereof, are also recorded on the blockchain 125 as events. In particular, a cryptographic hash of an event associated with each interaction is generated by the server, hashed and stored on the blockchain as an event hash 135.

FIG. 4 illustrates an embodiment of a delivered event item 400.

The delivered event item 400 includes an event identifier 305, an event name 310, specifying the type of event (in this case a ‘delivered’ event), and a timestamp 315 relating to when the message was delivered.

The structure of the delivered event item 400 may be applied to a variety of other events, such as ‘read’ events, by simply changing the event name. Furthermore, extended structures may be provided where any suitable data is concatenated to the event, which can be recognised through the event name 310.

The blockchain 125 generally comprises a plurality of blocks, wherein hashes of the events are stored as blocks on the blockchain 125. The blockchain 125 may, for example, comprise an Ethereum blockchain. Furthermore, while the term “blockchain” is used in singular, the skilled addressee will readily appreciate that any number of blockchains may be used together as a distributed ledger.

### Example Embodiment: Off-Chain Message Storage

In some embodiments, the message payload 200 is stored off-chain in a content store, while the blockchain 125 records only event data, cryptographic hashes and logical identifiers that indirectly reference the message payload 200. The payload 200 includes a payload identifier that uniquely identifies the payload independently of any particular physical storage location, for example a randomly generated string or universally unique identifier that does not encode a bucket name, file path or other storage details. The payload identifier is stored in an off-chain mapping store, such as a relational database, and is used as a primary key to a mapping record that contains information sufficient for the server 105 to later locate encrypted message content in the content store.

In an embodiment, when encrypted message content is to be stored, the server 105 generates the payload identifier and uploads the encrypted message content to the content store, which may be implemented using a cloud object storage service, file store or document database. The server 105 selects or determines storage location parameters such as a container or bucket identifier, a folder or prefix, and an object key, and stores the encrypted message content at the corresponding location in the content store. The server 105 then computes a first cryptographic hash over the encrypted message content, using a known hash algorithm such as SHA-256, and writes a mapping record into the off-chain mapping store keyed by the payload identifier. The mapping record includes at least the storage location parameters and the first cryptographic hash. Additional metadata, such as content length, content type, tenant identifier or an encryption key identifier, may also be stored in the mapping record.

The payload identifier and the first cryptographic hash are incorporated into a message event item that represents a particular lifecycle event for the message, such as a “sent” event or a “delivered” event, as described elsewhere in this specification. The message event item further comprises message lifecycle data including a message identifier, one or more user identifiers for the sender and recipient, a payload type and a timestamp. The message event item is serialised into a canonical representation, for example a JSON or binary document with a defined field ordering and encoding rules, such that repeated serialisation of the same logical event yields the same byte sequence. The server 105 computes a second cryptographic hash over this canonical representation, thereby generating an event hash that uniquely represents the combination of the payload identifier, the first cryptographic hash and the message lifecycle data.

The server 105 constructs a blockchain transaction that includes the event hash and, in some embodiments, a compact subset of event metadata such as the message identifier and timestamp, and submits the transaction to the blockchain 125. In this way, the blockchain 125 immutably records a commitment to the message event item without storing the message content itself and without embedding any direct reference to the physical storage location in the content store. Because the event hash is computed over a representation that includes both the payload identifier and the first cryptographic hash, the blockchain 125 effectively anchors a binding between “which payload is being referred to” and “what encrypted bytes that payload is expected to contain”.

When a subsequent request to access message content is received, for example from an authorised recipient device 115, the server 105 obtains the relevant payload identifier from a stored message event item or from data associated with the message. The server 105 uses the payload identifier as a key to query the off-chain mapping store and retrieve the corresponding mapping record, including the storage location parameters and the first cryptographic hash. Using the storage location parameters, the server 105 retrieves the encrypted message content from the content store. The server 105 then computes a third cryptographic hash over the retrieved encrypted message content, using the same hash function as for the first cryptographic hash, and compares the third cryptographic hash with the first cryptographic hash obtained from the mapping record.

If the third cryptographic hash matches the first cryptographic hash, the server 105 treats the retrieved encrypted message content as valid and, in one embodiment, decrypts the content using an appropriate decryption key before providing the resulting plaintext message to the authorised recipient. Because the same first cryptographic hash was also included in the message event item and indirectly anchored on the blockchain 125 via the event hash, a verifying user is able to confirm that the payload identifier, the mapping record and the retrieved encrypted message content are consistent with the event history recorded on the blockchain 125.

If the encrypted message content cannot be retrieved from the content store, for example because the underlying object has been deleted, moved or corrupted, or if the third cryptographic hash does not match the first cryptographic hash stored in the mapping record, the server 105 refrains from providing the message content to the requesting party. Instead, the server 105 generates a further message event item indicating an integrity failure condition associated with the payload identifier. This further message event item may include a failure type, error codes, and a timestamp in addition to the payload identifier and message identifier. The further message event item is serialised into the same canonical representation as other events, a further cryptographic hash is computed over the serialised representation, and a further blockchain transaction including the further cryptographic hash is submitted to the blockchain 125. In this way, the fact that the message content was unavailable or failed integrity verification is itself recorded as part of the immutable event history.

The interaction between the payload identifier, the mapping store and the blockchain event hashes results in a combination of features that operates differently from systems that simply store message content or a hash and URL pair on a blockchain. In the present arrangement, the payload identifier is a logical key that does not encode the physical storage path, and the mapping store provides an indirection layer that can be updated if content is migrated between storage locations or providers, without requiring any change to the event data already committed to the blockchain 125. The blockchain 125 commits only to canonicalised event items that include the payload identifier and the first cryptographic hash, so any change to the encrypted bytes associated with that payload identifier will cause subsequent hash comparisons to fail, and those failures are in turn written back to the blockchain as further events. As a result, the message content can remain in ordinary, mutable storage, and can be moved, archived or removed in accordance with operational and regulatory requirements, while the event history on the blockchain 125 still provides a tamper-evident record of what payload was expected at each point in time and whether or not that payload was successfully verified thereafter.

This combination provides technical benefits over more straightforward approaches. In one comparative arrangement, the entire message content, or an encrypted copy of it, is written directly to the blockchain; while such an approach provides straightforward integrity proofs, it also permanently exposes or embeds the content in an immutable ledger, increasing storage costs and making deletion or relocation effectively impossible. In another comparative arrangement, only a hash of the message and a fixed URL or file path are stored in each blockchain record; this approach ties the on-chain record directly to a specific storage layout, and any change in buckets, paths or storage providers risks breaking the association, while integrity checks are typically left to optional audit processes. In contrast, in the embodiments described above, the payload identifier and mapping record decouple the logical identity of the payload from its physical storage, and the first and third hashes enforce integrity at both write and read time. In some embodiments the generation of further integrity-failure events may be used to ensure that storage problems are themselves captured in the same event-sourced history. The coordinated operation of off-chain content storage, off-chain mapping and on-chain event hashing enables blockchain-grade auditability of message payloads without storing the payloads on the blockchain and while allowing the storage layer to evolve independently of the recorded event history.

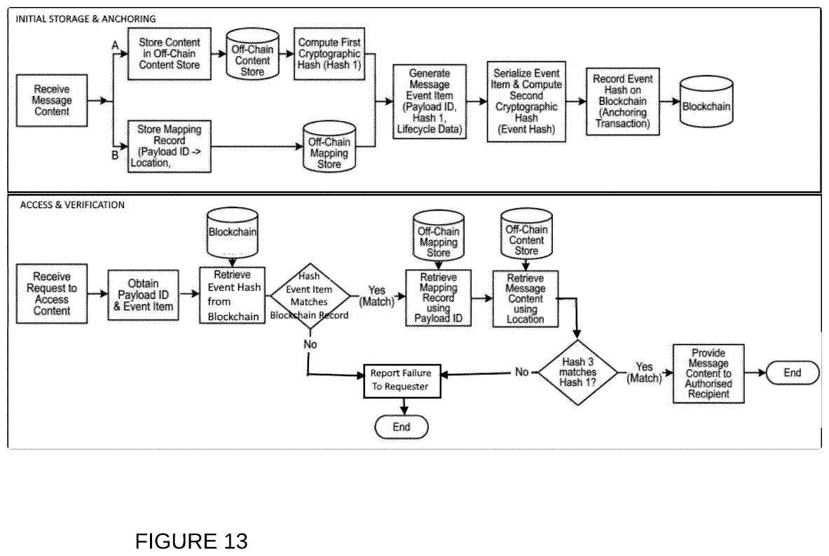

FIG. 13 of the drawings shows a flow diagram illustrating an embodiment of a computer-implemented method for managing message content using off-chain storage and blockchain-based event records. In an initial storage and anchoring phase, message content is received and a payload identifier is generated for that content. The message content is stored in an off-chain content store and a first cryptographic hash is computed over the stored content. In parallel, an off-chain mapping store is updated with a mapping record keyed by the payload identifier, the mapping record including at least location data for retrieving the message content from the off-chain content store and the first cryptographic hash. A message event item is then generated that includes at least the payload identifier, the first cryptographic hash and message lifecycle data. This message event item is serialised into a canonical representation, a second cryptographic hash is computed over the canonical representation to obtain an event hash, and a blockchain transaction including the event hash is recorded on a blockchain so as to immutably anchor the message event item without storing the message content itself on the blockchain.

FIG. 13 further illustrates an access and verification phase. A request to access the message content is received and the relevant payload identifier and an associated message event item are obtained. The associated message event item is serialised into the same canonical representation and a verification hash is computed over that canonical representation. The verification hash is compared with the event hash previously recorded on the blockchain for the associated message event item. If the verification hash does not correspond to the retrieved event hash, or if the event hash cannot be retrieved from the blockchain, the system refrains from providing the message content and reports a failure condition in response to the access request. If the verification hash corresponds to the retrieved event hash, the payload identifier is used to retrieve the corresponding mapping record from the off-chain mapping store and the location data in the mapping record is used to retrieve the message content from the off-chain content store. A third cryptographic hash is computed over the retrieved message content and compared with the first cryptographic hash obtained from the mapping record. If the third cryptographic hash matches the first cryptographic hash, the retrieved message content is treated as valid and is provided to an authorised recipient. If the message content cannot be retrieved from the off-chain content store, or if the third cryptographic hash does not match the first cryptographic hash, the system refrains from providing the message content and reports a failure to the requester.

In some embodiments, the hashing operations shown in FIG. 13 are implemented as streaming operations integrated into the normal read and write paths for the off-chain content store and the event store. When storing message content, the server 105 may stream the encrypted message bytes in chunks to the off-chain content store while, in parallel, feeding the same byte stream into a cryptographic hash function, such as a SHA-512 hash function or another secure hash function (for example SHA-256 or a SHA-3 variant), so that the first cryptographic hash is obtained without requiring a second pass over the data. When writing the message event item, the server 105 may serialise the event item into the canonical representation and compute the event hash in a similar streaming fashion before submitting the anchoring transaction to the blockchain. When retrieving message content during the access and verification phase, the server 105 may again stream the bytes returned from the off-chain content store through the hash function to compute the third cryptographic hash before any decryption is performed. This two-stage verification, in which the associated message event item is first checked against the blockchain record and the stored content is then checked against the integrity value held in the mapping record, provides a tamper-evident chain from the blockchain-anchored event history through to the off-chain content bytes that are ultimately provided, or withheld, in response to an access request. In further embodiments, when the third cryptographic hash does not match the first cryptographic hash or the content cannot be retrieved, the server 105 additionally generates a further message event item indicating an integrity failure condition associated with the payload identifier, serialises that further message event item, computes a further cryptographic hash over the serialised further message event item and records a corresponding blockchain transaction, thereby capturing integrity failures as part of the same immutable event history.

### Example Embodiment: Event-Sourcing Architecture for Managing Message Histories

In some embodiments, the system adopts an event-sourcing architecture for managing message histories, in which every change in the lifecycle of a message is represented as a separate, immutable event and the current state of the message is defined by the ordered sequence of those events rather than by a separately maintained mutable status record. Each message is assigned a unique message identifier at creation time, and this identifier is included in all subsequent events relating to that message.

Lifecycle changes for a given message can include, by way of example, a sending action, a delivering action, a reading action, a forwarding action, a deleting action and an integrity failure action. For each such lifecycle change, the server generates a corresponding message event that includes at least the unique message identifier, an event type identifying the particular lifecycle change and event metadata such as a timestamp and one or more user identifiers identifying the sender, recipient or other actors involved.

The message events are written to an event store in an append-only manner. In one embodiment, the event store is implemented using an event-sourcing database that associates each appended message event with the unique message identifier and maintains events for a given message in a defined sequence order. The server may assign a per-message sequence number to each event, such as a monotonically increasing version index, or may rely on ordering guarantees provided by the event-sourcing database. As a result, all events relating to a given message form an ordered event stream for that message. The event stream for a message therefore provides a complete, immutable history of the message lifecycle from initial creation and sending through to its final disposition, including any integrity failure events generated when content verification fails as described elsewhere in this specification.

In some embodiments, each message event further includes a payload identifier that uniquely identifies the message content independently of any physical storage location, and an integrity value associated with the message content, such as a cryptographic hash of the encrypted payload. As described in more detail in relation to off-chain message storage, the payload identifier is used as a key into an off-chain mapping store that contains a mapping record with location data for retrieving the message content from an off-chain content store and the integrity value computed for that content. By including the payload identifier and integrity value in the message events, the system links the event-sourced lifecycle history of the message to the off-chain content storage and integrity checking mechanism, so that both lifecycle changes and content integrity outcomes are reflected in the same event stream.

In an embodiment, each message event is also anchored to a blockchain. To achieve this, the server serialises the message event into a canonical representation, such as a JSON or binary encoding with a defined field order, and derives an event hash from the canonical representation, for example by computing a cryptographic hash. The server then submits a blockchain transaction that includes the event hash to a blockchain network, thereby immutably recording a commitment to the message event without storing the full event payload or the message content on the blockchain.

Optionally, selected metadata such as the unique message identifier or a transaction identifier can be included in or associated with the blockchain transaction. The event store thus provides the complete event payloads and per-message ordering, while the blockchain provides a tamper-evident ledger of event hashes that can be used to verify the integrity of the event history.

When the system is required to determine a current state of a message, for example in response to a request from a client application or a verifying user, the server retrieves the ordered event stream associated with the unique message identifier from the event store and processes the events in order according to a set of state transition rules. The server initialises a state representation for the message and, for each message event in sequence, applies a state transition based on the event type and event metadata. For example, a “sent” event may set the state to “sent” and record a sent timestamp, a “delivered” event may update the state to “delivered” and record a delivered timestamp, a “read” event may update the state to “read” and record a read timestamp, a “forwarded” event may update forwarding metadata, a “deleted” event may mark the message as deleted, and an “integrity failure” event may mark the message as untrusted or unavailable. After all events in the event stream have been processed, the resulting state representation is used as the current state of the message for responding to the request. In this way, the current state is defined directly by the ordered sequence of message events, rather than by a separate mutable status field that is updated in place.

In normal operation, the system may maintain one or more derived state stores built from the event streams. In one embodiment, a projection component subscribes to the event store and, when new message events are appended, updates read-optimised data structures such as relational tables or key-value indexes that map user identifiers to message identifiers and summarised status information. A user interface can then obtain an up to date list of messages and their current statuses for a particular user by querying the derived state store instead of replaying the full event streams. For higher-assurance operations, such as regulatory or forensic audits, the server can re-read the full event stream for one or more messages from the event store, recompute the state representation by replaying the events in sequence and verify that the event payloads correspond to the event hashes recorded on the blockchain. Any discrepancy between the recomputed state, the derived state store and the blockchain-anchored event hashes can be detected and flagged to a verifying user.

The event-sourcing architecture is closely integrated with the off-chain content storage and integrity checking discussed elsewhere in this specification. When message content is retrieved from the off-chain content store using the payload identifier and location data stored in the mapping record, the server derives a new integrity value from the retrieved content and compares this with the integrity value stored in the mapping record. If the integrity values correspond, the content is treated as valid and may be decrypted and provided to an authorised recipient. If the integrity values do not correspond or the message content cannot be retrieved, the server refrains from providing the content and generates an “integrity failure” message event that includes at least the unique message identifier, an event type indicating an integrity failure, the payload identifier and relevant metadata such as a timestamp and an error code. This integrity failure message event is appended to the event store as part of the event stream for that message and is processed in the same way as other events, including derivation of an event hash and recording of that hash on the blockchain. As a result, integrity failures are treated as first-class lifecycle changes in the same event-sourced history, and the current integrity status of the message is reflected in the state representation derived from the event stream.

The combination of features described above provides technical advantages over more conventional approaches. In a typical messaging system, each message may be represented by a mutable database row with a status column that is updated directly to values such as “sent”, “delivered”, “read” or “deleted”, and separate log tables may be used to record user actions for audit purposes. In such systems, the current state is taken from the mutable status column, the logs are often considered secondary, and it is possible for an operator to change the status field or alter log entries without an external party being able to detect those changes. Even if some log entries or occasional snapshots are recorded on a blockchain, the audit information is not used as the primary source of state, and inconsistencies between the main database, the logs and the blockchain may not be obvious. Another known alternative is to store full message content or message snapshots directly on the blockchain, possibly with timestamps and hashes, to provide strong integrity guarantees; however, this significantly increases blockchain storage requirements, exposes sensitive content to additional risk and makes it practically impossible to delete or relocate message content while preserving privacy and compliance with data protection requirements.

By contrast, in the embodiments described herein, the event-sourced message history, off-chain content storage and blockchain anchoring are used together in a coordinated manner. The only authoritative record of what has happened to a message is the ordered event stream, which is append-only and anchored to a blockchain via event hashes; the current state of the message is derived by applying state transition rules to that event stream, and there is no separate, primary mutable status record. The payload identifier and mapping record decouple the logical identity of the message content from its physical storage location, allowing the content store to be reconfigured, migrated or segmented without altering the event history or the blockchain records. Integrity checking is integrated into the normal access path for message content, and any integrity failure results in a new message event that becomes part of the same immutable event stream and is anchored on the blockchain. This combination allows the system to provide blockchain-grade, tamper-evident auditability of both message lifecycle and content integrity while keeping message content in flexible off-chain storage and maintaining practical performance via derived state stores, thereby offering a more robust and adaptable solution than the more straightforward but inferior alternatives described above.

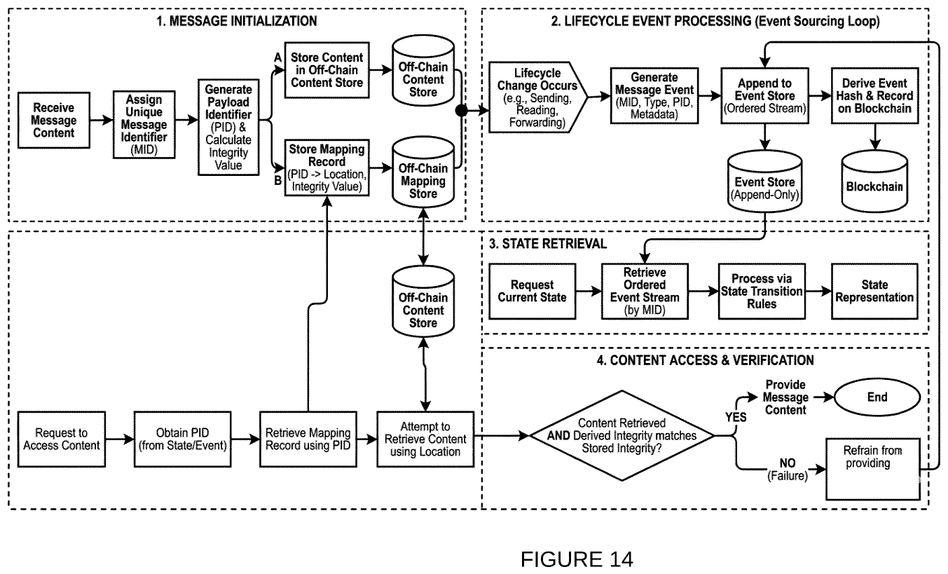

FIG. 14 of the drawings shows a flow diagram illustrating an example computer-implemented method for managing secure messages using event-sourced histories together with off-chain content storage and blockchain-based verification. In a first phase, labelled “Message Initialisation”, message content is received and a unique message identifier (MID) is assigned to the message. A payload identifier (PID) is then generated for the message content, the PID being a logical identifier that does not encode any physical storage location. At the same time, an integrity value is calculated for the message content, for example by applying a cryptographic hash function to the stream of bytes that constitute the encrypted message content. In one embodiment the integrity value is computed as the content is being written, so that the same byte stream is both uploaded to the off-chain content store and fed into the hash algorithm. The content is stored in an off-chain content store, and a mapping record keyed by the PID is written to an off-chain mapping store. The mapping record associates the PID with location data for retrieving the stored content (such as a bucket and object key) and with the integrity value calculated for that content.

FIG. 14 further illustrates a second phase, “Lifecycle Event Processing (Event Sourcing Loop)”, in which each lifecycle change for the message is represented as an immutable event. When a lifecycle change occurs, such as sending, reading, forwarding, deleting or detecting an integrity failure, the server generates a message event that includes at least the MID, an event type indicating the nature of the lifecycle change, the PID and event metadata such as timestamps and user identifiers. The message event is appended in an append-only manner to an event store so that, for each MID, the event store maintains an ordered event stream describing the lifecycle of the message. The message event is then serialised into a canonical representation and an event hash is derived from that representation, for example by computing a cryptographic hash. A blockchain transaction that includes the event hash is recorded on a blockchain, thereby immutably anchoring the message event without storing the message content itself on the blockchain. The “Event Sourcing Loop” arrow indicates that this process repeats for each subsequent lifecycle change, so that the event store and blockchain together hold a complete, ordered history of message events.

A third phase, “State Retrieval”, shows how the system derives a current state of a message from the event-sourced history. In response to a request for the current state, the server retrieves the ordered event stream associated with the MID from the event store and processes the events using state transition rules. These rules map event types (for example “sent”, “delivered”, “read”, “deleted” or “integrity failure”) to updates of a state representation. By applying the events in order, the server obtains a state representation that reflects the current status of the message and any associated metadata, and this state representation is used when responding to the request. The figure thus illustrates that the current state of the message is defined by the ordered sequence of stored events rather than by a separately maintained mutable status field.

A fourth phase, “Content Access & Verification”, illustrates how content retrieval is tied into the same framework. When a request to access the message content is received, the system obtains the PID, for example from the state representation or from a latest message event, and uses the PID to retrieve the mapping record from the off-chain mapping store. Using the location data in the mapping record, the system attempts to retrieve the content from the off-chain content store. Once retrieved, an integrity value is derived from the retrieved content using the same hashing algorithm as used during initialisation, and this derived integrity value is compared with the integrity value stored in the mapping record. If the content is successfully retrieved and the derived integrity value matches the stored integrity value, the message content is provided to an authorised recipient and the flow terminates. If the content cannot be retrieved or the integrity values do not correspond, the system refrains from providing the content and instead generates an “integrity failure” message event, which is appended to the event store and processed in the same lifecycle event loop as other message events, including derivation of an event hash and recording of that hash on the blockchain. In this way, FIG. 14 shows that both the current state and the integrity status of the message are defined by the ordered sequence of blockchain-anchored message events, while the content itself remains in off-chain storage.

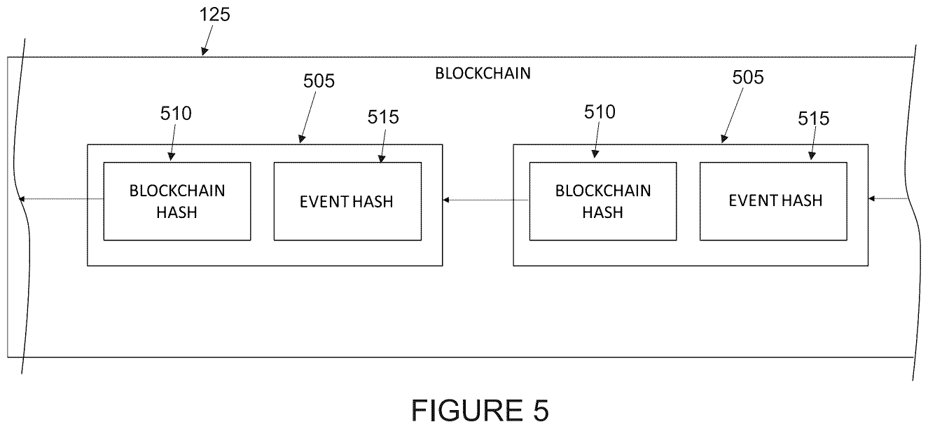

FIG. 5 illustrates a simplified schematic of a portion of the blockchain 125, according to an embodiment of the present invention.

The blockchain includes blocks 505, which are linked to each other in a chain using a blockchain hash 510, comprising a hash of the previous block 505. The use of a chain of hashes, comprising hashes of the previous blocks 505, prevents blocks 505 in the blockchain from being replaced, as this would break the chain of hashes.

The blocks 505 further include an event hash 515, comprising a hash of the message or transaction.

When an event is initially created, the event hash 515 comprises a hash of the event, as outlined above. This enables any user to determine that the event has not been modified or replaced. Furthermore, the event may include hashes of a message residing off the blockchain, thereby enabling a user to determine that the message has also not changed.

While not illustrated, the skilled addressee will readily appreciate that any suitable type of data may also be stored in the blocks 505, but is not shown in the simplified schematic for the sake of clarity. For example, timestamps, headers and the like may be stored in the block and outside of the event hash 515.

The communications system 100 enables users 110 to communicate with each other in a secure manner, while maintaining an auditable record on a blockchain 125. By storing hashes of messages and all associated events that follow it, including those by the recipient, an audit of all transactions can be made, while maintaining confidentiality of the data.

This is achievable as the users 110 identify themselves before both sending and receiving data, and that communications are encrypted end-to end, meaning that even if the server 105 is compromised, data is not leaked.

In some cases, however, messages may be sent without encryption. As an illustrative example, messages comprising non-sensitive data may be sent in unencrypted form. In such case, the use of the blockchain 125 is still beneficial as it provides transparency and enables verification that messages have not been tampered with.

Furthermore, in addition to providing the data store 120 for storing communications, the data store 120 may be used for secure file storage. In such cases, end-to-end encryption need not be used between a sender and recipient, but instead encryption to and from the data store may be used. For example, AES-256 encryption may be used when communicating directly with the data store to access a file.

While the above embodiments illustrate users connecting directly to the server 105 and data store 120, in other embodiments, third party systems (not illustrated) may access the server 105 and/or data store 120.

In one or all embodiments, the third party systems comprise Secure Message Delivery (SMD) systems in the healthcare industry. In such cases, the system 100 may support messages according to the Clinical Document Architecture (CDA) standard, and be used for eReferrals, specialist letters, prescriptions, lab results, diagnoses outcomes, discharge summaries and similar. The skilled addressee will, however, readily appreciate that any suitable third-party systems may be used, and in any industry, including outside of the healthcare industry.

When third party systems are used, the various interactions described above as occurring on the computing devices 115, such as encryption, may be performed by the third-party system.

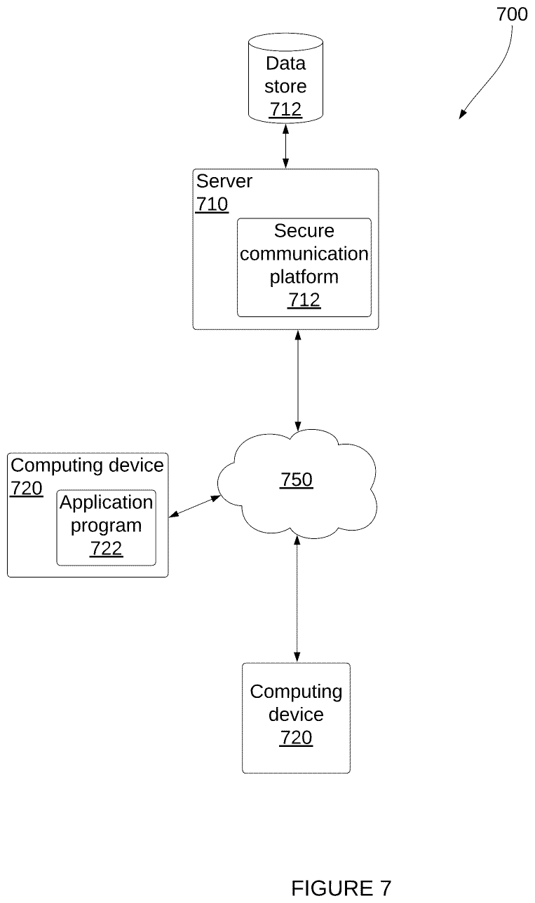

Referring to FIG. 7 of the drawings, a communications system 700 includes one or more servers 710 that provide a secure communication platform 712, through which secure communications may be made by sending secure messages from a sender to a recipient. The servers 710 include or are coupled to a data store 712, which stores secure communications and/or related data.

A sender interacts with the secure communication platform 712 on the server 710 using a user computing device 720, such as a personal computer. In one or all embodiments the one or more servers 710 function in part as a web server, and the secure communication platform 712 provides user interfaces with which the sender interacts. In one or all embodiments a user's computing device 720 may run an application program 722 configured to connect the user's computing device 720 to the platform 712 via a network 750 (for example a large area network, LAN, the internet, or other digital communication network, or a combination of interconnected communication networks).

In other embodiments the communication system 700 may be configured to operate in a different type of configuration, for example a client-server architecture where the server 710 may be a server host, and the platform 712 may comprise the server software that provides the functionality of the communication system 700.

The computing devices 720 are in communication with the server 710 over the network 750. In an exemplary embodiment, the application program 722 is provided by the server 710 and is accessed by the users of the system from a user computing device 720 via an online web application, thereby accessing the services provided by the platform 712.

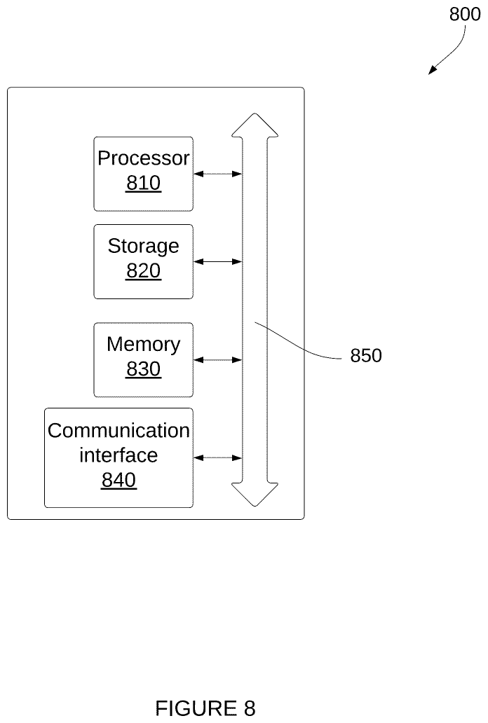

FIG. 8 is a block diagram of an example embodiment of a computing device 800 that can be used in the system described herein, for example as a user computing device 720 and/or as one or more of the servers 710 illustrated in FIG. 7 of the drawings. Each computing device 800 includes a processor 810, storage 820, memory 830, and a communication interface 840 (also referred to as a “data interface” herein) for communicating with other computing devices. The various components of the computing device 800 are interconnected via a bus 850. This configuration may be implemented using a bespoke computing device, or in one or all embodiments standard devices such as a mobile phone, tablet, desktop computer or laptop may be used.

### Embodiments of Communications Methods

In one or all embodiments, a communications method comprises generating or receiving a message associated with at least one recipient; generating an event item associated with the message; generating, using the at least one processor, a cryptographic hash of at least part of the message and/or the event item; storing, on a blockchain, the cryptographic hash(es) or a derivative thereof; and then enabling a recipient of the message to access, on the data interface, the message.

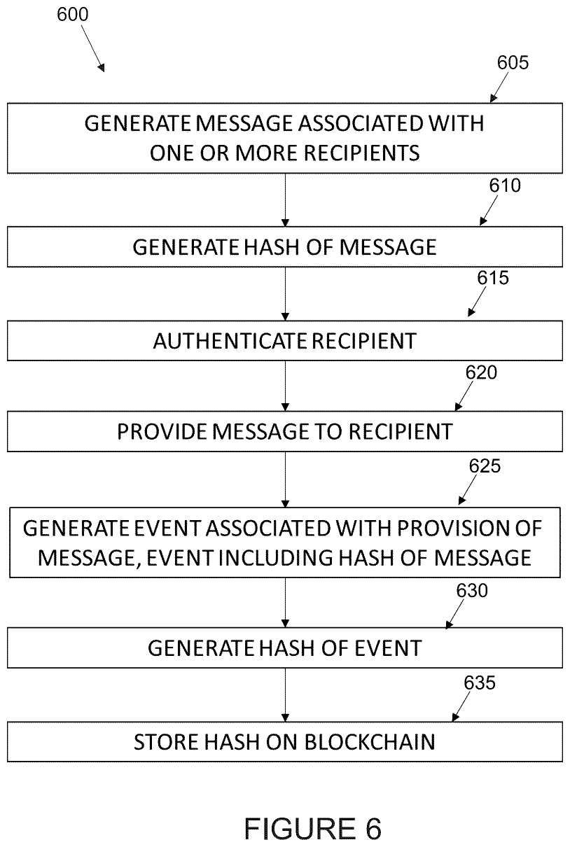

FIG. 6 illustrates a communications method 600, according to an embodiment of the present invention. The communications method 600 may be similar or identical to the method performed by the system 100.

At step 605, a message is generated, the message associated with one or more recipients. The message may be associated with one or more recipients using user IDs of the recipients, or other identifiers or addresses of the recipients. In one or all embodiments, at step 605 the message may be received and not generated, for example via a user input or from a connected messaging source or application.

In one or all embodiments, step 605 may include generating an event item associated with the message.

The message may include any type of data, such as text, images, audio, files, etc. In one or all embodiments, the message comprises an eReferral, a specialist letter, a prescription, lab results, a diagnosis outcome, or a discharge summary. In other embodiments, the message comprises an invoice, a quote, a letter, or any other suitable document or data.

The message may be encrypted. The message may be encrypted using end-to-end encryption.

A sender may be authenticated prior to or upon receipt of the message therefrom. This may be performed using a digital signature of the sender, or any suitable method.

At step 610, a cryptographic hash of the message is generated. In one or all embodiments, multiple cryptographic hashes of the message are generated, including a hash of the message prior to encryption, and a hash of the message once encrypted.

Additionally or alternatively, in one or all embodiments, step 610 may include generating a cryptographic hash of one or more event items associated with the message.

The hash is generated according to a known hash algorithm, such as the Secure Hash Algorithm 3 (SHA-3) to generate a binary string of 224, 256, 384, or 512 bits. By using a known (and pre-defined) algorithm, others are able to rehash the message, and compare the hash with that generated above.

In one or all embodiments, creating and storing a cryptographic hash of an event on a blockchain may include one or more of the following steps:
a. Event Data: Generate the data associated with the event that will be stored securely on the blockchain. This could include details like event type, timestamp, relevant identifiers (e.g., message ID, sender, receiver), and any other metadata.
b. Hash Function: Choose, retrieve, or otherwise access a cryptographic hash function, such as SHA-256, which takes an input (in this case, the event data) and produces a fixed-size output (the hash value).
c. Calculating the Hash: Apply the chosen hash function to the event data to generate the cryptographic hash value. The hash function should produce a unique and deterministic output for a given input, meaning the same event data will always produce the same hash value.
d. Blockchain Transaction: Prepare a transaction to store this hash value on the blockchain. Depending on the blockchain platform, the transaction may be formatted according to its specifications, including details like gas fees (for Ethereum) or transaction fees (for Bitcoin).
e. Transaction Execution: Execute the transaction by submitting it to the blockchain network for inclusion in a block. (Miners or validators on the blockchain network process the transaction, ensuring that it meets the consensus rules of the blockchain.)
f. Confirmation: Once the transaction is confirmed and included in a block, the cryptographic hash of the event data is stored on the blockchain. This hash serves as a secure and tamper-proof representation of the original event data.

By storing cryptographic hashes of events on a blockchain, a verifiable record of events is created that ensures data integrity and immutability. Incorporating the event data into a blockchain may comprise one or more methods such as smart contracts, off-chain data anchoring, permissioned blockchains, sidechains or layer 2 solutions, zero-knowledge proofs (ZKPs), and/or interoperability protocols, as known in the field of blockchain technology.

At step 615, a recipient of the message is authenticated. This may, for example, be in response to a request from the recipient to access the message. In one or all embodiments, the recipient is notified of the presence of a message, enabling the recipient to request access to same.

The recipient may be authenticated using any suitable means, including using a digital signature.

Upon authentication of the recipient, the message is provided to the recipient in step 620. The (encrypted) message may be stored on a data store, and a link to the message be provided to the recipient.

At step 625, an event item associated with provision of the message is generated. The event item may include a (or multiple) hashes of the message, an event identifier, a timestamp, and/or details of the sender and recipient(s).

At step 630, a cryptographic hash of the event item is generated, similarly using a known hash algorithm.

At step 635, the event item hash is stored on the blockchain. This enables parties to independently verify that the message has been provided to the recipient.

By storing the hash on the blockchain, information from the message, as well as the senders and receivers, may remain confidential, while providing the ability to audit already known information. The event hash on the blockchain allows for auditing the messaging process without providing access to any confidential details associated with the sender, recipient, or message content.

The method 600 may include validating the message using the blockchain. The message may be validated by generating a hash of the message, generating an event item to include the hash of the message, hashing the event item, and comparing the hash of the event item with a hash recorded on the blockchain.

Similarly, the method 600 may include generating further event items relating to interactions with the message, and storing hashes of one or more of these event items on the blockchain. These further event items may be validated by regenerating the hash and comparing the hash to the corresponding value found on the blockchain.

Advantageously, the methods and systems described herein enable confidentiality, auditability and authentication to be provided when parties communicate data, such as documents or other communications, with each other remotely.

By storing the cryptographic hash of the message interactions on the blockchain, an immutable record of the message activity is able to be provided, without storing or disclosing the message on the blockchain. This may in turn enable auditing to be performed in a transparent manner, without compromising the data of the message.

By enabling every action to be validated on the blockchain through a peer-to-peer network, sensitive data may be sent and received without the risk of data tampering, which in turn breaks down the barriers of distrust.

Furthermore, the methods and systems may be used with end-to-end encryption, meaning that even if there is a leak and/or other compromise of a server of the system, sensitive data will not be leaked.

The event item may include one or more authentication indicators or identifiers. For example, the event item may include a timestamp, and/or an event identifier that is unique across a plurality of events.

The methods described herein may include authenticating, using a processor in the system, an intended recipient of the message being sent, and providing the message is then in response to successfully authenticating the recipient. This may be done, for example, using a digital signature, such as one generated using public key private key cryptography. The digital signature may comprise an electronic, encrypted stamp of authentication.

Additionally or alternatively, the methods described herein may include authenticating the sender using a digital signature. The digital signature may be generated using public key private key cryptography. The digital signature may comprise an electronic, encrypted stamp of authentication.

Requests made against the HTTPs APIs may require authentication so that the server runs the requested actions when the correct user requests them. As an example, the server may receive a request to READ a particular message. Before providing the message details to the caller, the server needs to ensure that the requester is either the sender or the recipient of the particular message. To do this, the server authenticates that the requester is one of the allowed parties, for example using hash-based message authentication code (or HMAC), a cryptographic technique that combines public keys, private keys, and a hash into a combination not susceptible to hackers.

When building the request object, the system includes “replay protection” fields in the request, such that each command can only be issued once.-This protects the system described herein against “replay attacks” where an attacker “sniffs” the network data sent and replays it numerous times to repeat the request.

The “replay protection” fields consist of a timestamp and a random number (or string). The server records all random numbers/strings received within a given time-window. If the same random number is received, the request is rejected as a duplicate. If the attacker waits until the time-window expires before resending, the request is rejected as it is “stale”.

In summary, the requester builds an object that specifies what action they need the server to perform. This object is then bundled with “replay-protection elements” that the server has not seen before. The requester signs this request using the requesting object and their Private Key. The requester includes their Public key, along with the signed request object, and the signature, in the HTTP API call. The Server validates the signature using the Public key provided in the call. The server performs “replay protection” checks. Finally, the server ensures the Public Key belongs to an authorised user before performing the request.

The sender and receiver may be associated with user identifiers (IDs). Public and private keys may be associated with the user IDs. The sender and receiver may be verified prior to allocation of a user ID. The method may include verifying the sender and/or receiver using a phone number, fax number, or email address. The method may include receiving identity documents of the user, such as a driver's license, and performing an identity check based thereon.

The message may be associated with at least one recipient using the user ID of the at least one recipient. The user ID may be published on an online directory. The online directory may include other details of the user, such as a name, address or the like. The online directory may be searchable. The user ID may be associated with one or more of a fax number, a mobile number and an email address. Such configuration enables messages to be sent to a user using a fax number, a mobile number and an email address, without necessarily knowing the user ID.

The method may include performing third-party verification of an identity of a user. Different levels of verification may be used based upon a role of the user.

In one or all embodiments, the method may include generating event items relating to interactions with the message. In this way, it is possible to audit the message by tracking any changes made to the message. The interactions may include delivering a message to an inbox of the recipient, the recipient viewing a message, and/or the recipient sharing a message.

The events may include or be associated with metadata. The metadata may include (but not be limited to) timestamp data, a sender identifier and a recipient identifier.

The message itself may be encrypted, for example using a public key of the recipient, e.g., prior to being received by a server. The method may further include encrypting, at a computing device of the sender, the message. As such, end-to-end encryption may be provided between the sender and recipient.

The method may include sending a notification to the receiver that the message is available for viewing.

The method may include sending the message to the recipient on a data interface. The message may be sent in response to a request from the recipient.

The recipient may be authenticated when requesting the message.

The message may comprise text. The message may include one or more of documents, images, audio, text, or files.

The method may include storing at least part of the message on a data store. The message may be stored on the data store in an encrypted manner. The data store may encrypt data using AES-256 encryption.

The message may be, at least partly, automatically generated. The message may be generated as part of a workflow.

The method may include validating the message by regenerating the cryptographic hash.

The method may include validating one or more interactions with the message using the blockchain.

In one or all embodiments, a non-transitory computer-readable medium includes instruction code stored thereon, the instruction code when executed by one or more processors, causing the one or more processors to execute one or more steps of the methods described herein. For example the instruction code when executed by one or more processors, may cause the one or more processors to: generate a message associated with at least one recipient; generate a cryptographic hash of at least part of the message; store, on a blockchain, the cryptographic hash or a derivative thereof; and enable a recipient of the at least one recipient to access, on the data interface, the message.

In alternative embodiments, event sourcing and blockchain technologies may be combined to enhance secure messaging by using event sourcing for real-time state management and periodically storing hashed snapshots on the blockchain for integrity checks. In other embodiments, event sourcing may be used for detailed auditing while selectively logging critical message events on the blockchain. Alternatively, a hybrid model can employ blockchain smart contracts for automated security enforcement alongside event sourcing for comprehensive transaction history. Another embodiment may include using blockchain for decentralised identity management while event sourcing manages messaging events. In one or all alternative embodiments, interoperable systems can maintain separate event sourcing and blockchain setups, verifying data alignment periodically to ensure integrity and security without fully merging the systems. These embodiments all aim to leverage the strengths of both technologies to provide robust security, efficient state management, and comprehensive auditing capabilities for secure messaging platforms.

### Event Items

The methods described herein include generating an event item relating to the message, and generating a cryptographic hash of the event item that is then is stored on a blockchain.

As used herein an “event item” refers to a state change in a message transmission application, as logged using event sourcing. Event sourcing focuses on capturing and storing the state changes of an application as a sequence of immutable events. These events represent changes in the system's state over time and are stored in an append-only manner. Instead of directly storing the current state, an event sourcing system records a history of all the changes, or events, that have occurred. In this way, event sourcing is primarily concerned with maintaining a historical record of state changes for auditability, reproducibility, and understanding past states of the system.

These events represent changes in state and are stored in a specialised database known as an event store. The event store acts as the system of record for all state changes and can be implemented using databases optimised for this purpose, like EventStoreDB, Apache Kafka, or traditional databases configured in an append-only mode.

In embodiments described herein, the event item may include a cryptographic hash of the message. The message may be encrypted, and the event item may include a cryptographic hash of the encrypted message.

Cryptographic hashes of the event items are stored on a blockchain.

In this way, two data-storage mechanisms are combined: blockchain and event sourcing. The event-sourcing database holds a list of events that occur to messages, e.g. “Sent”/“Delivered”/“Read” etc. The events are private data held on system servers and only accessible to the users who are message participants. At the time these events are written, the hash of the events is calculated and stored on the public blockchain.

By storing the hashes in a publicly accessible way, on an immutable source, the system ensures that the hashes do not change after being written. As these hashes “fingerprint” the private events, they can be used to confirm that the events have not changed by recalculating the hashes and comparing them to those found on the blockchain.

When an action occurs relating to a message (such as: “the act of sending a message”) an object is generated to represent the particular details of this action. Using the example of “sending a message”, the system records:
a. A unique ID to represent this particular action,
b. Who the message was from,
c. Who the message is to,
d. Details of the actual message content (such as “location of the recorded message on our servers”, “hash of the message content” etc.)
e. What action was occurring: e.g.: “SENT”
f. What time the action occurred.

The method then adds this event item to the event-sourcing database.

The method serialises the content of the event item (for example using JSON serialisation, but any lossless serialisation technique such as “Protocol Buffers” (https://protobuf.dev) could be used).

The method then generates the cryptographic hash of the serialised content. Specifically, the server uses the SHA-512 secure hashing algorithm, but this can be generalised to any hash such as SHA-256.

Using a “smart-contract”, the unique ID of the action, and its cryptographic hash is written to the blockchain.

The content of the message is encrypted at rest, for example using a key exchange and cipher such as a Diffe-Hellman key exchange and an XSalsa20 cipher. The sender side of the system performs a hash (e.g., using SHA512) of the message content both before and after encryption. The before/after encryption hashes are included in the “SENT” action object of the event item.

By including this metadata as part of the event item, and then ensuring that this event item is also verifiable against a record kept on the blockchain, the system server can verify that the received message is the message that the sender originally sent and that no subsequent manipulation of the message has occurred.

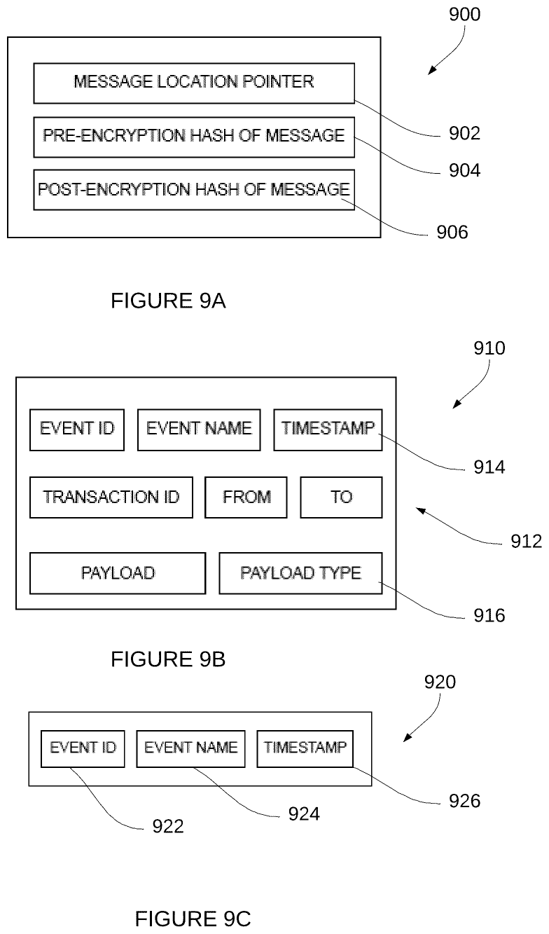

FIG. 9A shows an embodiment of an encrypted text message payload 900.

The sender of the message creates a document containing the unencrypted message. The sender side of the system records the hash of this document (PRE-ENCRYPTION HASH 904), encrypts the document, notes the hash of the encrypted document (POST-ENCRYPTION HASH 906), and uploads this encrypted document to a storage server. This upload can be located via the MESSAGE LOCATION POINTER 902. These three details 902, 904, 906 form the payload 900 of the message.

In other embodiments, rather than creating an unencrypted document, the sender may send a well-known type of file (e.g. PDF) or an arbitrarily complex data-object.

Event objects, also referred to as “event items” herein, are held in an event-sourcing database. The event item is hashed, and this event item hash value is stored on a blockchain, e.g. the public blockchain. This ensures immutability of the message, because the message is determined by the aggregation of its events. At any time, it is possible to retrieve each event, perform the hashing operation, and compare the hash to the one held on the blockchain.

FIG. 9B shows an embodiment of a sent event item 910. The Sent event item 910 contains the PAYLOAD. The Sent event hash is used to determine whether the PAYLOAD has been altered. The PAYLOAD contains pre/post encryption hashes. This makes it possible to determine whether the message document has changed by hashing the document and comparing that to the hashes stored in the payload.

Extra events can be defined as required, for example events may include “Forwarded”, “Deleted”, “Responded” etc.

When the user sends the message, the sent event item 910 is generated. Every event contains event item data fields 912, and these may include one or more of:
a. EVENT ID—A Globally unique identifier for the event
b. EVENT NAME—Specifying the type of event. (In this case: “Sent”)
c. TIMESTAMP 914—Specifying when the event was generated
d. The “Sent” event contains additional information:
e. TRANSACTION ID—A Globally unique identifier used to identify a particular message
f. FROM—The “user-identification” of the message sender
g. TO—The “user-identification” of the message recipient
h. PAYLOAD 916—data relevant to the document being sent. (in this example the
i. “Encrypted Text Message Payload”)
j. PAYLOAD TYPE—to help identify how to interpret the PAYLOAD FIG. 9C shows an embodiment of a delivered or read event item 920. A Delivered or Read Event item 920 includes:
a. EVENT ID 922—A Globally unique identifier for the event
b. EVENT NAME 924—Specifying the type of event. (For example, either “Delivered” or “Read”)
c. TIMESTAMP 926—Specifying when the event was generated

The API defines which message to apply this event to, so no further fields are required to convey further information about the message.

In some embodiments, the system manages secure message lifecycles using a defined set of lifecycle event types, an append-only event store and blockchain anchoring. Rather than maintaining a single mutable “status” field for each message, the system treats every significant lifecycle change of a message as a separate, structured event. The current state of the message, including at least a trust status and a resolution status, is derived from the ordered sequence of these events.

At initialisation, when message content is received from a sending device, the system creates a message record and assigns a unique message identifier MID (also referred to as TRANSACTION ID) to that record. The MID is used to correlate all subsequent events and state for that message. Separately, as a configuration step for the messaging system, a finite set of message lifecycle event types is defined. In one embodiment, this finite set includes at least: an event type representing message transmission, an event type representing message receipt, an INTEGRITY-FAILURE event type and/or a RESOLVED event type. Additional event types may also be defined, for example event types representing actions such as “read”, “forwarded”, “deleted” or “delivery failure”. The same finite set of event types is reused across all messages handled by the system, which ensures that lifecycle semantics are consistent and machine-interpretable.

Each lifecycle change that occurs for a message results in the generation of a message event instance of one of the defined event types. A message event includes a set of core fields, such as: the unique message identifier, an event type identifier, a timestamp and event metadata identifying one or more actors associated with the event (for example sender and recipient identifiers). For some event types, the event also includes additional fields. For example, events may carry a payload identifier and an integrity value associated with off-chain message content, as described elsewhere in this specification, and a RESOLVED event includes a resolution payload describing a resolution of the message, such as an acceptance, completion or other outcome together with structured resolution data.

In some embodiments, the event type identifier used in the state transition rules corresponds to, or is derived from, the EVENT NAME field described with reference to FIGS. 9A to 9C; for example, the EVENT NAME “Sent” may correspond to a transmission event type.

When a lifecycle change occurs, the server determines which of the defined event types applies and generates a message event instance accordingly. For example, when a new message is successfully transmitted, a transmission event is generated with the MID, event type, timestamp, sender and recipient identifiers and a payload component. When a delivery confirmation is received from a secure messaging network or downstream system, a receipt event is generated recording the MID, recipient identifier, timestamp and channel information. In some embodiments, when an integrity mismatch or missing content is detected during content access, an INTEGRITY-FAILURE event is generated recording the MID, payload identifier, timestamp and an error code. When the request or instruction conveyed by a message is resolved, for example when a referral is accepted or an appointment completed, a RESOLVED event is generated that includes the MID, timestamp and a resolution payload describing the outcome.

Each generated message event is appended, in an append-only manner, to an event store in association with the unique message identifier. The event store maintains events grouped by message identifier and, for each MID, stores events as an ordered event stream. In one implementation, the event store assigns a sequence index to each event per MID so that the order of lifecycle events for the message is well defined. Because events are appended but never overwritten or deleted, the event store provides a complete and immutable history of the lifecycle changes for each message.

For each message event, the system derives an event hash representative of the event. In one embodiment, the event is serialised into a canonical representation, for example a JSON or binary encoding with a defined field ordering and encoding rules, and a cryptographic hash function is applied to the canonical representation. The resulting event hash is then recorded on a blockchain in a blockchain transaction. The blockchain thus immutably anchors the ordered event stream by committing to the hash of each message event, without storing the full event payload or the message content on the blockchain. The combination of the append-only event store and the blockchain ledger allows later verification that a given set of events has not been altered.

When the system needs to determine the current state of a message, the event-sourced lifecycle model is used. In response to a request for a current state of a particular message, the system retrieves the ordered event stream associated with the MID from the event store and processes the events according to state transition rules. The state transition rules map event types to updates of a state representation. For example, a transmission event may set an initial status of “sent”; a receipt event may update the status to “delivered” and record a delivery timestamp; a read event may update the status to “read”; and a delete event may mark the message as deleted for a particular user. The rules may further include special mappings, for example an INTEGRITY-FAILURE event causes the state representation to mark the message as “not trusted” or “untrusted”, and/or a RESOLVED event causes the state representation to mark the message as “resolved” and associate the resolution payload with that state. After all events in the event stream have been processed in order, the resulting state representation reflects the current state of the message, including at least a trust status and a resolution status, and is used as the basis for responding to the state request.

In this architecture, the current state of the message is not maintained as a separately updated mutable status field in a message record. Any change to the state must be expressed as a lifecycle event of one of the defined types, appended to the event store and anchored on the blockchain. As a result, there is a single, replayable source of truth for message state: the ordered sequence of stored, blockchain-anchored message events. A verifier can reconstruct the same state by retrieving the event stream, reapplying the state transition rules and optionally verifying that the event payloads match the corresponding event hashes recorded on the blockchain.

Various business rules may be applied when deciding whether to generate a new lifecycle event. For example, only one transmission event may be permitted per MID, representing the initial sending of the message, while multiple receipt events may be permitted to represent delivery to multiple recipients or devices. The system may generate a single RESOLVED event per MID as a primary resolution, with subsequent resolution-related actions treated as annotations or updates. In some embodiments, an INTEGRITY-FAILURE event may be generated whenever a derived integrity value for retrieved content does not match the stored integrity value, and the system may prevent message content from being shown to users in such cases until an INTEGRITY-FAILURE event has been recorded. In other embodiments, there is no recording of an INTEGRITY-FAILURE event, and the system prevents the message content from being shown to the users.

This lifecycle management approach provides several technical advantages over more conventional designs. In a typical messaging system, each message is represented in a database by a row containing a status column that is updated in place (for example “sent”, “delivered”, “read”, “deleted” or “failed”), and separate log tables or files record assorted actions for auditing. In such systems, the authoritative notion of state is the mutable status field, and the logs are incomplete, inconsistent and not used directly to determine state. It can be difficult or impossible to reconstruct an exact history of what happened to a message, or to detect and prove if the status has been changed retrospectively. Error conditions such as integrity failures may be transiently logged, if at all, and business-level outcomes such as “resolved” are often not represented explicitly.

By contrast, in the embodiments described here, state and history are unified. Because there is a finite, well-defined set of lifecycle event types and every change is represented as an instance of one of those types, the event stream for a message gives a precise, machine-readable explanation of how the message reached its current state. Integrating special event types such as INTEGRITY-FAILURE and/or RESOLVED into the same framework helps to ensure that trust and resolution are treated as first-class properties rather than as separate flags or external processes. Anchoring every event hash on a blockchain means that it is very difficult for an operator to modify or remove events without detection, improving the trustworthiness of the audit trail. At the same time, because the blockchain stores only hashes of events and not the message content itself, storage overhead and privacy concerns are reduced compared to approaches that write full messages or full logs to a blockchain.

In addition, the use of a defined lifecycle vocabulary and state transition rules enables consistent behaviour across different components and deployments. Client applications, servers and verifying tools can interpret and display message histories based on the same event types and rules. For example, a verifying user may request the state of a message and see not only that the message is “resolved and trusted”, but also, by inspecting the event stream, when transmission occurred, when and to whom it was delivered and read, whether any integrity failures occurred and how and when the message was ultimately resolved. Alternative designs that rely on ad-hoc logs, free-form status messages or occasional snapshots to a blockchain do not provide the same level of determinism, auditability and machine-interpretable semantics for secure message lifecycles.

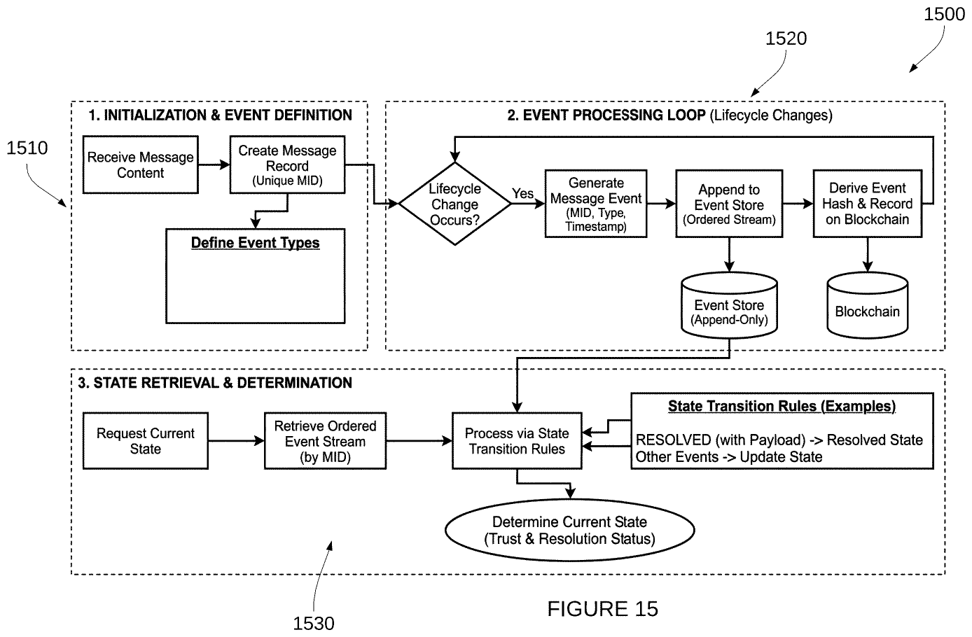

FIG. 15 of the drawings shows a flow diagram illustrating an example computer-implemented method 1500 for managing secure message lifecycles using defined lifecycle event types, an append-only event store and blockchain anchoring.

In a first phase 1510, labelled “Initialization & Event Definition”, message content is received and the system creates a message record having a unique message identifier (MID). Separately, as a system-configuration step, the messaging system defines a finite set of message lifecycle event types, including at least an event type for message transmission, an event type for message receipt, and a RESOLVED event type that is associated with a resolution payload. This definition of event types is typically performed once for the system or per deployment, and the same set of event types is then reused for all messages. Some embodiments may include an INTEGRITY-FAILURE event type.

A second phase 1520, labelled “Event Processing Loop (Lifecycle Changes)”, shows how lifecycle changes are captured as events. When a lifecycle change occurs for the message, such as a transmission, receipt, integrity failure or resolution, the system generates a message event corresponding to one of the defined event types. The generated message event includes at least the unique message identifier (MID), an event type identifier (implemented as the EVENT NAME field), and a timestamp. Each message event is appended, in an append-only manner, to an event store so that events associated with the same MID form an ordered event stream for that message. For each message event, an event hash representative of the event is derived, for example by serialising the event into a canonical representation and computing a cryptographic hash, and the event hash is recorded on a blockchain. In this way, the ordered event stream is immutably anchored on the blockchain without storing the message content itself on the blockchain.

A third phase 1530, labelled “State Retrieval & Determination”, illustrates how the system derives the current state of a message from the ordered, blockchain-anchored event stream. In response to a request for the current state of a particular message, the system retrieves the ordered event stream associated with the MID from the event store and processes the events according to state transition rules. As indicated in the “State Transition Rules (Examples)” box, these rules map the defined event types to message status values, mapping a RESOLVED event that includes a resolution payload to a state in which the message is marked “resolved”, and mapping other event types to updates of other aspects of the message state. Some embodiments may include mapping an INTEGRITY-FAILURE event to a state in which the message is marked “not trusted”. By applying the state transition rules to the ordered event stream, the system determines the current state of the message, including at least a trust status and a resolution status, as illustrated by the “Determine Current State (Trust & Resolution Status)” block. No separate mutable status field is updated in this flow; instead, the current state is defined entirely by the ordered sequence of stored message events and their associated event hashes recorded on the blockchain.

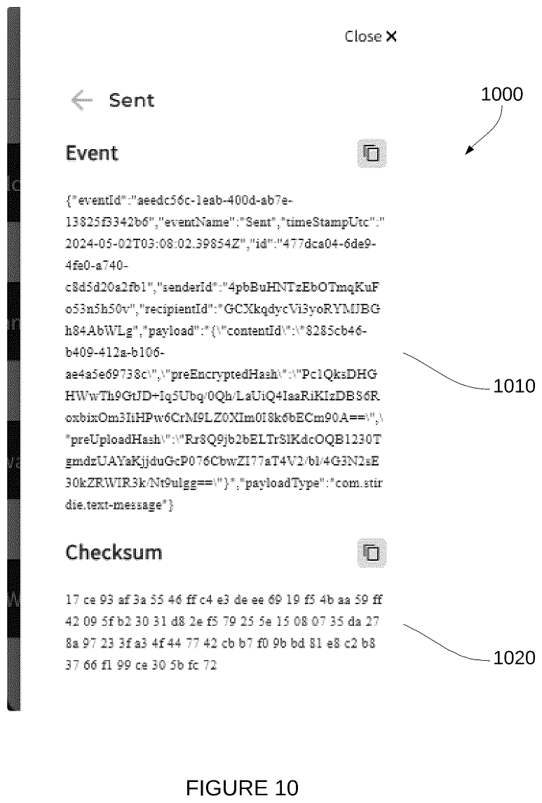

FIG. 10 shows an embodiment of a user interface display 1000. The event data 1010 describes actions that have occurred to the message being investigated. The event data 1010 has been serialised in JSON format, and captures data relevant to the action that has occurred. It includes the “eventID” which is the unique identifier. The “checksum” 1020 shows the result of the hash operation that was applied to the serialised event at the time it was written (i.e., this was the data stored on the blockchain). The server has used the blockchain smart-contract to retrieve the hash for this particular event by referencing the eventID.

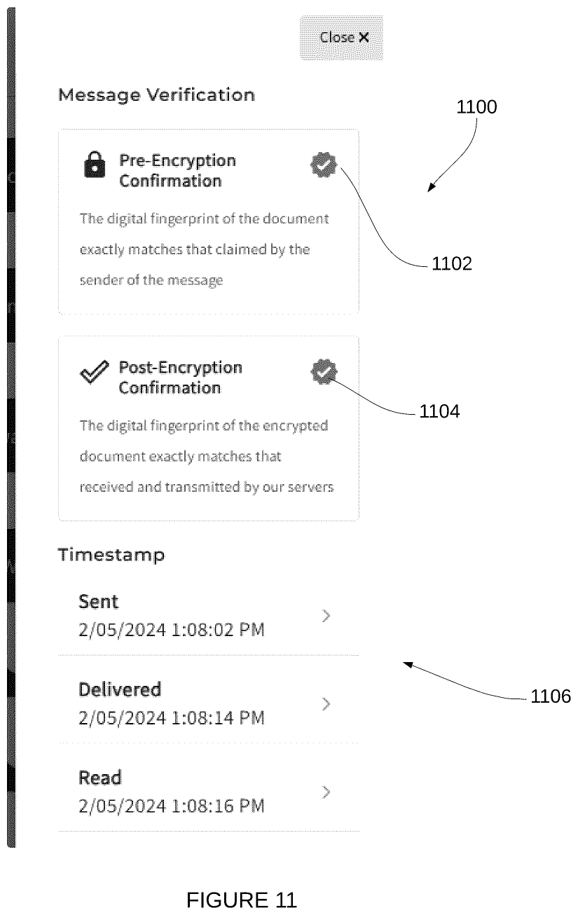

FIG. 11 shows another embodiment of a user interface display 1100. The receiving application will decrypt the message content and perform a cryptographic hash on the content. This should match the hash recorded in the “sent” event. A tick 1102 indicates that the calculated hash matched the recorded hash and thus can guarantee the message has not changed in transit.

The receiving application also performs the hash operation on the encrypted message content. This also uses a tick 1104 to indicate that the originating party encrypted the message before sending. As the encryption technique includes an element of randomness, failing this check would indicate that the message had been re-encrypted without being altered. The three events that have occurred to the message are shown with timestamps 1106.

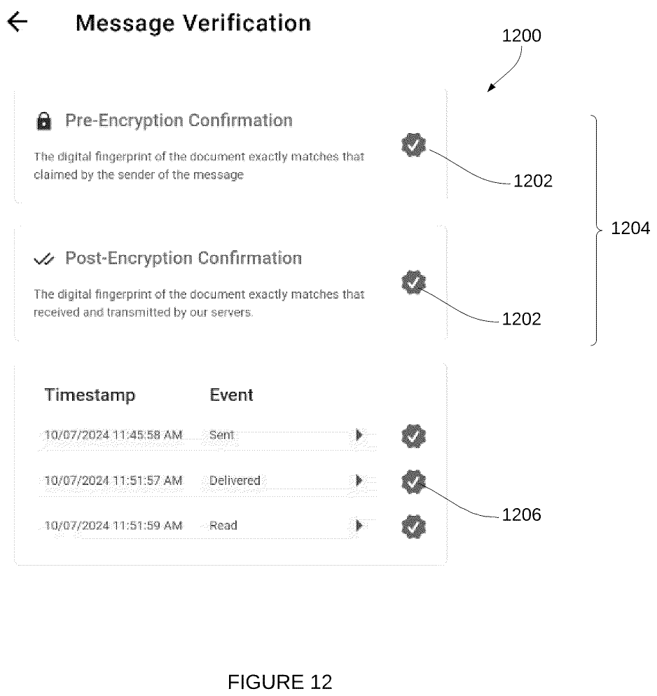

FIG. 12 shows another embodiment of a user interface display 1200 of the message verification page from a mobile phone application. As per the web-site display shown in FIG. 11, the mobile display 1200 shows that hash calculations are performed on the encrypted and decrypted document to ensure the message has not been tampered with. This is indicated with the ticks 1202 in the top two fields 1204. The mobile display 1200 also shows the events that have occurred over the course of the message's lifetime. Ticks 1206 are used to show that the events have not been tampered with since the time the events were recorded. The ticks 1206 are indicators that the message has been transmitted securely. This is possible because the mobile app retrieves the recorded hashes from the blockchain, and performs the same calculated hash on the event data. The mobile phone application explicitly performs the process of hashing the event-data and comparing calculated hash with the blockchain recorded hash. Successful verification of the calculated versus recorded hash results in the tick 1206 next to the event in question. An error-icon would be shown in the event of a hash that does not match, indicating a change in the data.

### Example Embodiments

Clause 1. A computer-implemented method for managing secure messages using off-chain content storage and blockchain-anchored event-sourced histories, the method comprising:
receiving message content associated with a message;
creating a message record having a unique message identifier; generating a payload identifier for the message content, the payload identifier uniquely identifying the message content independently of any physical storage location;
storing the message content in an off-chain content store;
computing an integrity value over the stored message content;
storing, in an off-chain mapping store, a mapping record keyed by the payload identifier, the mapping record including at least location data for retrieving the message content from the off-chain content store and the integrity value associated with the message content;
defining, in the messaging system, a finite set of message lifecycle event types including at least an event type for message transmission, an event type for message receipt, an INTEGRITY-FAILURE event type and a RESOLVED event type;
for each lifecycle change associated with the message, including at least a sending action and one or more actions selected from delivering, reading, forwarding, deleting and reporting an integrity failure, generating a message event of one of the defined event types, the message event including at least the unique message identifier, an event type identifier, a timestamp and event metadata, and for at least some event types further including the payload identifier and the integrity value;
appending each generated message event, in an append-only manner, to an event store in association with the unique message identifier so as to form an ordered event stream for the message;
for each message event, deriving an event hash representative of the message event and recording the event hash on a blockchain, thereby immutably anchoring the ordered event stream without storing the message content on the blockchain;
responsive to a request for a current state of the message, retrieving the ordered event stream from the event store and processing the ordered event stream according to state transition rules that map the defined event types to message status values, including mapping an INTEGRITY-FAILURE event to a state in which the message is marked not trusted and mapping a RESOLVED event, the RESOLVED event including a resolution payload describing a resolution of the message, to a state in which the message is marked resolved, so as to obtain a state representation used as the current state of the message; and
responsive to a request to access the message content, obtaining the payload identifier from the state representation or from a message event in the ordered event stream, using the payload identifier to retrieve the mapping record from the off-chain mapping store and the location data in the mapping record to retrieve the message content from the off-chain content store, deriving a further integrity value from the retrieved message content and comparing the further integrity value with the integrity value stored in the mapping record, and when the further integrity value does not correspond with the integrity value stored in the mapping record or the message content cannot be retrieved, refraining from providing the message content and generating a further message event of the INTEGRITY-FAILURE event type, the further message event being appended to the event store and anchored on the blockchain in the same manner as other message events,
wherein a current state of the message, including at least a trust status and a resolution status, is determined from the ordered sequence of stored, blockchain-anchored message events and is not maintained as a separately updated mutable status field.

Clause 2. The method of clause 1, wherein the payload identifier is generated as a logical identifier that does not encode the off-chain content store or a physical storage path, and the mapping record provides an indirection layer between the payload identifier and a physical storage location of the message content.

Clause 3. The method of clause 1 or clause 2, wherein the off-chain mapping store comprises an indexable database and the mapping record is a database row keyed by the payload identifier, the database row including at least a content store type, a container or bucket identifier and an object key.

Clause 4. The method of any one of clauses 1 to 3, wherein the integrity value comprises a cryptographic hash of the message content.

Clause 5. The method of any one of clauses 1 to 4, wherein deriving the event hash comprises serialising the message event into a canonical representation and computing a cryptographic hash over the canonical representation such that repeated serialisation of the same logical message event yields the same event hash.

Clause 6. The method of any one of clauses 1 to 5, wherein the event store maintains a per-message event stream in which message events associated with a given unique message identifier are stored and retrieved in sequence order.

Clause 7. The method of any one of clauses 1 to 6, wherein the finite set of message lifecycle event types further comprises at least a SEND event type and a DELIVERED event type, the SEND event type corresponding to transmission of the message content and the DELIVERED event type corresponding to receipt of the message at a recipient endpoint.

Clause 8. The method of any one of clauses 1 to 7, wherein each message event further includes the payload identifier that identifies message content stored in the off-chain content store and the integrity value associated with the message content.

Clause 9. The method of any one of clauses 1 to 8, wherein an INTEGRITY-FAILURE event is generated whenever an integrity value derived from retrieved message content does not correspond with the integrity value stored for that content, and the INTEGRITY-FAILURE event is used to block subsequent access attempts to the message content via the payload identifier and to provide an auditable indication that the message content was unavailable or failed integrity verification at a recorded time.

Clause 10. The method of any one of clauses 1 to 9, wherein the RESOLVED event includes the resolution payload comprising at least a resolution code and structured resolution data, and at most one RESOLVED event is permitted as a primary resolution for a given unique message identifier, any subsequent RESOLVED events for that unique message identifier being treated as updates or annotations to an existing resolution state in the state transition rules.

Clause 11. The method of any one of clauses 1 to 10, wherein the state transition rules map event types in the ordered event stream to message status values including at least one of: sent, delivered, read, forwarded, deleted, integrity failed and resolved.

Clause 12. The method of any one of clauses 1 to 11, wherein retrieving the ordered event stream and processing the ordered event stream according to the state transition rules is performed for audit operations by a verifying user, and, for normal user-facing operations, a derived state store updated from the event store is queried to provide current message lists and statuses.

### Advantages

Advantageously, the methods and systems described herein provide the benefits derived from both event sourcing as well as blockchain technology in order to provide a tamperproof record of message transmission. The unique combination of event sourcing and blockchain technology allows for auditability, traceability, and security in a secure messaging system.

While both event sourcing and blockchain emphasise immutability and a historical record of changes, their implementation and use cases differ significantly. Event sourcing is typically used in software architecture to manage state within applications, providing benefits like auditability and debugging capabilities. Blockchain is used to create decentralised and secure systems where participants can trust the integrity of the data without needing a central authority.

The current technologies do not combine these two methods, because event sourcing is primarily an architectural pattern for managing state changes in software systems, whereas blockchain is a technology for creating secure, decentralised ledgers. Event sourcing databases and blockchain methods are rarely combined in a single solution because they serve different purposes and have distinct design considerations. Event sourcing is used within software architectures to manage state changes and maintain a detailed history for applications, focusing on centralized performance and efficiency. In contrast, blockchain is designed for decentralised, secure transaction recording, emphasising trust, transparency, and data integrity across multiple participants. Combining these approaches is generally thought to introduce unnecessary complexity and overhead, as their mechanisms for achieving immutability and historical records differ significantly. Normally, event sourcing's centralised optimisation contrasts with blockchain's decentralised consensus and cryptographic security. Given their differing use cases and operational contexts, combining them is typically thought to result in redundant complexity without clear benefits, making it seem impractical and unintuitive.

In the current technology, it is generally considered that blockchain methods would be more suitable for a secure messaging platform where ensuring messages are secure and not tampered with is crucial.

The inventors have found, however, that combining event sourcing and blockchain technologies for a secure messaging platform could yield several benefits, leveraging the strengths of both approaches. For example, event sourcing can efficiently manage the state changes and history of messages within the system, while blockchain ensures the security, integrity, and immutability of these messages.

By using event sourcing, the platform described herein is able to capture every action and state change related to messages, such as message creation, delivery, and receipt confirmations. This detailed audit trail can help in debugging, analytics, and replaying events to understand the message flow. Blockchain is used to record hashes of these events (and even the messages themselves), ensuring that once recorded, the event items cannot be tampered with. Each block in the blockchain contain a hashes of the previous blocks, creating a secure and tamper-proof chain of records.

To combine these technologies, each message and its associated events (like sending, receiving, and reading) are captured using an event sourcing system, which logs these events in an append-only store. For each critical event, a hash of the event data is created and recorded on the blockchain. This ensures that any tampering with the events can be detected by comparing the current event data with the hash stored on the blockchain. The platform can periodically take snapshots of the current state to optimise performance and reduce the need to replay all events from the beginning. The blockchain provides a decentralised, immutable ledger of these event hashes, which ensures that the sequence and integrity of messages can be independently verified by any participant in the network.

By combining these technologies, the platform benefits from the efficient state management and detailed event tracking of event sourcing, along with the robust security and tamper-proof guarantees of blockchain. This hybrid approach provides a comprehensive solution that addresses both the performance and security requirements of a secure messaging platform.

Advantageously, in the combination methods described herein, the event sourcing database is used as a transaction history, and the blockchain verifies that this transaction history has not been altered after the event. In other words, the event sourcing database functions as the detailed transaction history, while the blockchain provides the verification mechanism to ensure that this history remains unaltered. This combination leverages the efficient state management and detailed tracking capabilities of event sourcing along with the robust security and immutability of blockchain technology.

It will be understood to persons skilled in the art of the invention that many modifications may be made without departing from the spirit and scope of the invention.

1. A computer-implemented method for managing message content using off-chain storage and blockchain-based event records, the method comprising:
receiving message content associated with a message;
generating a payload identifier that uniquely identifies the message content independently of any physical storage location;
storing the message content in an off-chain content store;
computing a first cryptographic hash over the stored message content;
in an off-chain mapping store, storing a mapping record keyed by the payload identifier, the mapping record including at least location data for retrieving the message content from the off-chain content store and the first cryptographic hash;
generating a message event item that includes at least the payload identifier, the first cryptographic hash and message lifecycle data;
serialising the message event item into a canonical representation and computing a second cryptographic hash over the canonical representation to obtain an event hash;
recording, on a blockchain, a blockchain transaction that includes the event hash, thereby immutably anchoring the message event item without storing the message content on the blockchain;
responsive to a subsequent request to access the message content, obtaining the payload identifier and an associated message event item;
serialising the associated message event item into the same canonical representation and computing a verification hash over the canonical representation;
retrieving, from the blockchain, the event hash recorded for the associated message event item and comparing the verification hash with the retrieved event hash;
when the verification hash does not correspond to the retrieved event hash or the event hash cannot be retrieved from the blockchain, refraining from providing the message content;
when the verification hash corresponds to the retrieved event hash, using the payload identifier to retrieve the mapping record from the off-chain mapping store and using the location data in the mapping record to retrieve the message content from the off-chain content store;
computing a third cryptographic hash over the retrieved message content and comparing the third cryptographic hash with the first cryptographic hash obtained from the mapping record;
when the third cryptographic hash matches the first cryptographic hash, treating the retrieved message content as valid and providing the message content to an authorised recipient; and
when the third cryptographic hash does not match the first cryptographic hash or the message content cannot be retrieved from the off-chain content store, refraining from providing the message content.

2. The method of claim 1, wherein the payload identifier is generated as a logical identifier that does not encode the off-chain content store or a physical storage path, and the mapping record provides an indirection layer between the payload identifier and a physical storage location.

3. The method of claim 1, wherein the off-chain mapping store comprises an indexable database and the mapping record is a database row keyed by the payload identifier, the database row including at least a content store type, a container or bucket identifier and an object key.

4. The method of claim 1, wherein the message event item represents a specific lifecycle event for the message selected from the group consisting of: message sent, message delivered, message read, message replied, message forwarded and message deleted.

5. The method of claim 1, wherein the canonical representation of the message event item is a structured data encoding with a defined field ordering such that repeated serialisation of the same logical event item yields the same byte sequence for hashing.

6. The method of claim 1, further comprising, when the third cryptographic hash does not match the first cryptographic hash or the message content cannot be retrieved from the off-chain content store:
generating a further message event item indicating an integrity failure condition associated with the payload identifier;
serialising the further message event item and computing a further cryptographic hash over the serialised further message event item; and
recording, on the blockchain, a blockchain transaction that includes the further cryptographic hash,
wherein the further message event item is used to block subsequent attempts to access the message content via the payload identifier and to provide an auditable indication to a verifying user that the message content was unavailable or failed integrity verification at a recorded time.

7. A computer-implemented method for managing secure messages using event-sourced histories with off-chain content storage and blockchain-based verification, the method comprising:
receiving message content associated with a message;
assigning a unique message identifier to the message;
storing the message content in an off-chain content store;
generating a payload identifier for the message content, the payload identifier being independent of a physical storage location of the message content;
storing, in an off-chain mapping store, a mapping record keyed by the payload identifier, the mapping record including at least location data for retrieving the message content from the off-chain content store and an integrity value associated with the message content;
for each lifecycle change associated with the message, including at least a sending action and one or more actions selected from delivering, reading, forwarding and deleting, generating a message event comprising at least the unique message identifier, an event type identifying the lifecycle change, the payload identifier and event metadata;
appending each message event, in an append-only manner, to an event store in association with the unique message identifier so as to form an ordered event stream for the message;
for each message event, deriving an event hash representative of the message event and recording the event hash on a blockchain, thereby immutably anchoring the ordered event stream without storing the message content on the blockchain;
responsive to a request for a current state of the message, retrieving the ordered event stream from the event store and processing the ordered event stream according to state transition rules to obtain a state representation used as the current state of the message; and
responsive to a request to access the message content, obtaining the payload identifier from the state representation or from a message event in the ordered event stream, using the payload identifier to retrieve the mapping record from the off-chain mapping store and the location data in the mapping record to retrieve the message content from the off-chain content store, comparing an integrity value derived from the retrieved message content with the integrity value stored in the mapping record, and when the integrity values do not correspond or the message content cannot be retrieved, refraining from providing the message content, such that the current state of the message is derived from the ordered sequence of stored, blockchain-anchored message events together with results of integrity checks performed when the message content is accessed, rather than from a separately maintained mutable status record.

8. The method of claim 7, wherein the integrity value comprises a cryptographic hash of the message content.

9. The method of claim 7, wherein deriving the event hash comprises serialising the message event into a canonical representation and computing a cryptographic hash over the canonical representation.

10. The method of claim 7, wherein the event store maintains a per-message event stream in which message events associated with a given unique message identifier are stored and retrieved in sequence order.

11. The method of claim 7, wherein the state transition rules map event types in the ordered event stream to message status values including at least one of: sent, delivered, read, forwarded and deleted.

12. The method of claim 7, further comprising, when the integrity values do not correspond or the message content cannot be retrieved:
generating a further message event indicating an integrity failure condition for the message;
appending the further message event to the event store in association with the unique message identifier; and
deriving a further event hash representative of the further message event and recording the further event hash on the blockchain in the same manner as other message events, such that subsequent audit operations can identify the integrity failure condition from the ordered event stream.

13. A computer-implemented method for managing secure message lifecycles, the method comprising:
receiving message content and creating a message record having a unique message identifier;
defining, in a messaging system, a finite set of message lifecycle event types including at least an event type for message transmission, an event type for message receipt and a RESOLVED event type;
for each lifecycle change that occurs for the message, generating a message event of one of the defined event types, the message event including at least the unique message identifier, an event type identifier and a timestamp;
appending each generated message event, in an append-only manner, to an event store in association with the unique message identifier so as to form an ordered event stream for the message;
for each message event, deriving an event hash representative of the message event and recording the event hash on a blockchain, thereby immutably anchoring the ordered event stream without storing the message content on the blockchain; and
responsive to a request for a current state of the message, retrieving the ordered event stream from the event store and processing the ordered event stream according to state transition rules that map the defined event types to message status values, including mapping a RESOLVED event, the RESOLVED event including a resolution payload describing a resolution of the message, to a state in which the message is marked resolved,
wherein the current state of the message, including at least a resolution status, is determined from the ordered sequence of stored, blockchain-anchored message events and is not maintained as a separately updated mutable status field.

14. The method of claim 13, wherein the finite set of message lifecycle event types further comprises at least a SEND event type and a DELIVERED event type, the SEND event type corresponding to transmission of the message content and the DELIVERED event type corresponding to receipt of the message at a recipient endpoint.

15. The method of claim 13, wherein each message event further includes a payload identifier that identifies message content stored in an off-chain content store and further includes an integrity value associated with the message content, the integrity value comprising a cryptographic hash of the message content.

16. The method of claim 13, wherein deriving the event hash comprises serialising the message event into a canonical representation and computing a cryptographic hash over the canonical representation such that repeated serialisation of the same logical message event yields the same event hash.

17. The method of claim 13, further comprising:
defining, in the finite set of message lifecycle event types, an INTEGRITY-FAILURE event type;
generating an INTEGRITY-FAILURE event when an integrity value derived from retrieved message content does not correspond with an integrity value stored for that content; and
appending the INTEGRITY-FAILURE event to the ordered event stream for the message and anchoring the INTEGRITY-FAILURE event on the blockchain in the same manner as other message events,
wherein the state transition rules map the INTEGRITY-FAILURE event to a state in which the message is marked not trusted.

18. The method of claim 13, wherein at most one RESOLVED event is permitted as a primary resolution for a given unique message identifier, and any subsequent RESOLVED events for that unique message identifier are treated as updates or annotations to an existing resolution state in the state transition rules.
